(19) United States
(12) Patent Application Publication
(10) Pub. No.: US 2001/0037219 A1
(43) Pub. Date: Nov. 1, 2001

(54) Systems, methods and computer program products for facilitating one-to-one secure on-line communications between professional services providers and remotely located clients

(76) Inventor: Stephen Nabeil Malik, Raleigh, NC (US)

Correspondence Address: Needham J. Boddie, II, Myers Bigel Sibley & Sajovec, Post Office Box 37428, Raleigh, NC, 27627, US

(21) Appl. No.: 09/838,878

(22) Filed: Apr. 20, 2001

Related U.S. Application Data
(60) Provisional application No. 60/200,091, filed on Apr. 27, 2000.

(51) Int. Cl. G06F 17/60

(52) U.S. Cl. 705/2; 705/3; 705/4

(57) ABSTRACT

Systems, methods, and computer program products are provided that can facilitate providing secure, on-line communications between healthcare providers and remotely located patients. Patients, during on-line virtual office visits, provide various information about one or more medical conditions in a predetermined, structured format. Patients are assigned to pools of patients based upon one or more patient attributes and/or one or more healthcare provider attributes. A healthcare provider qualified to treat patients in the pool selects a patient from a displayed list and views the medical condition of the patient. The physician prepares a diagnosis and/or treatment recommendation for the medical condition(s) of the patient and sends a communication containing the same to a secure area. The patient is then notified of the physician's communication and is directed to log-on to the secure area and view the communication.

### RELATED APPLICATIONS

This application claims the benefit of U.S. Provisional Application No. 60/200,091, filed Apr. 27, 2000, the disclosure of which is incorporated herein by reference in its entirety as if set forth fully herein.

### RESERVATION OF COPYRIGHT

A portion of the disclosure of this patent document contains material to which a claim of copyright protection is made. The copyright owner has no objection to the facsimile reproduction by anyone of the patent document or the patent disclosure, as it appears in the Patent and Trademark Office patent file or records, but reserves all other rights whatsoever.

### FIELD OF THE INVENTION

The present invention relates generally to professional services and, more particularly, to systems, methods, and computer program products for providing professional services.

### BACKGROUND OF THE INVENTION

Currently, the most prevalent use of the Internet for healthcare is as an information resource. It has been estimated recently that 44% of all adults in the United States access the Internet, and that 68% of these (about 60 million people) use the Internet to seek healthcare information. By the year 2005, it is predicted that 88.5 million adults will use the Internet to find healthcare information and to shop for healthcare products.

Patient-focused on-line physician consultations (sometimes referred to as “telemedicine”) are being used for specific applications among university medical centers, to reach rural communities and/or to handle emergency situations. The most common application in this context is to digitally send X-rays or other test results to a remote specialist physician for diagnosis, usually within a hospital network.

While the Internet is becoming a key conduit for information, professional mobility and changes in the healthcare system in the United States spawned by managed care have diluted the strength of the traditional physician-patient relationship. It is generally believed that physicians want to improve their patient care relationships.

Results of a recent survey indicate that consumers want on-line access to their physicians, including the ability to communicate with their physicians via e-mail. Unfortunately, on-line consultations for individual patients may be somewhat limited at present. Healinx (www.healinx.com), Medivation (www.medivation.com), Salu.net (www.salu.net), MedWired (www.medwired.com), and Healtheon (www.healtheon.com) provide on-line healthcare services. However, these on-line healthcare service providers may not be geared towards improving the relationship between healthcare providers and their patients. The traditional time-consuming in-person visit with a physician is still the primary method of obtaining healthcare services for individuals.

### SUMMARY OF THE INVENTION

In view of the above discussion, embodiments of the present invention provide systems, methods, and computer program products that can facilitate providing secure, on-line communications between professional service providers and remotely located clients. According to embodiments of the present invention associated with the healthcare industry, a method of providing healthcare services to patients includes accepting remote entry from patients about one or more medical conditions, assigning patients to pools based on entered patient information, allowing healthcare providers qualified to treat patients in the pool view the patient information, and providing a secure area within which healthcare providers and patients can communicate.

According to embodiments of the present invention, a patient accesses a “virtual office” of a healthcare provider via a client program executing on a client device (e.g., a Web browser executing on a client device). The virtual office may be represented as a series of Web pages served by a Web server. Upon identifying the patient as an existing patient, or accepting the patient as a new patient, the virtual office verifies that the patient is eligible to receive healthcare services. Once verified, the virtual office obtains various personal and medical information in a predetermined, structured format from the patient during the patient's “virtual visit.”

Using the information obtained during the patient's virtual visit, the patient is assigned to a pool, or queue, of patients based upon one or more attributes of the patient and/or one or more attributes of one or more healthcare providers (e.g., physicians). A physician qualified to treat patients in the pool selects the patient from a displayed list and views the medical condition of the patient. The physician prepares a diagnosis and/or treatment recommendation for the medical condition(s) of the patient and sends a communication containing the same to a secure area. The patient is then notified of the physician's communication and is directed to log-on to the secure area and view the communication.

According to embodiments of the present invention, a treatment recommendation provided by a physician may include a medication prescription, and the medication prescription may be automatically communicated to a pharmacy for fulfillment on behalf of the patient.

According to embodiments of the present invention, a treatment recommendation provided by a physician may include a request for laboratory services to be performed on a patient, and the request may be automatically communicated to a provider of laboratory services for fulfillment.

Embodiments of the present invention may be advantageous to both patients and healthcare providers, alike. By interacting with healthcare providers on-line, patients may receive quicker, more convenient and immediate treatment than conventionally. Moreover, patients can obtain access to quality healthcare from the convenience of their own home and/or office. By empowering healthcare providers with a secure method of communicating with their patients for the execution of administrative tasks as well as the delivery of care and treatment plans, healthcare providers may enhance relationships with their patients.

In addition, on-line consultations with patients may allow healthcare providers to generate additional income without requiring additional hours or out-of-pocket expenditures. Moreover, the present invention may provide healthcare providers with added flexibility in their practice, by enabling them to conduct patient consultations when it is convenient to them, anywhere, anytime, from an Internet connection.

Similarly, embodiments of the present invention may be advantageous to various other professional services providers including, but not limited to legal service providers, technical service providers, financial service providers, and their respective clients. Clients may receive quicker, more convenient services and professional services providers may enhance their relationships with clients, while also enhancing revenue.

### BRIEF DESCRIPTION OF THE DRAWINGS

FIG. 1 is a schematic illustration of a system that can facilitate providing secure, on-line communications between healthcare service providers and remotely located patients according to embodiments of the present invention.

FIG. 2 is a block diagram of a data processing system for use in implementing the server of FIG. 1.

FIGS. 3-4 are flow charts of systems, methods and/or computer program products that can facilitate providing secure, on-line communications between healthcare service providers and remotely located patients according to embodiments of the present invention.

FIG. 5 illustrates an exemplary log-on screen for the Web site of a healthcare provider.

FIGS. 6, 7, 8A-8B, 9A-9C, 10A-10B, 11 illustrate exemplary screens utilized by a patient during a virtual office visit, according to embodiments of the present invention.

FIGS. 12, 13, 14A-14B, 15A-15B, 16 illustrate exemplary screens utilized by a healthcare provider during a virtual consultation with a patient, according to embodiments of the present invention.

FIG. 17 is an exemplary e-mail message for notifying a patient of a communication from a healthcare provider, according to embodiments of the present invention.

FIGS. 18, 19, 20, 21, 22 illustrate exemplary screens utilized by a patient in viewing a communication from a healthcare provider containing a diagnosis and/or treatment recommendation for a medical condition of the patient, according to embodiments of the present invention.

FIGS. 23A-23B illustrate an exemplary screen for use by patients in requesting appointments with a healthcare provider, according to embodiments of the present invention.

FIGS. 24A-24B illustrate an exemplary screen for use by healthcare providers in accepting and/or denying appointment requests by patients, according to embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In overview, embodiments of the present invention relate to facilitating one-to-one communications between professional service providers and remotely located clients in a secure environment. As will be appreciated by one of skill in the art, the present invention may be embodied as methods, data processing systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including, but not limited to, hard disks, CD-ROMs, optical storage devices, and magnetic storage devices.

Computer program code for carrying out operations of the present invention may be written in an object oriented programming language such as JAVA®, Smalltalk or C++. The computer program code for carrying out operations of the present invention may also be written in conventional procedural programming languages, such as “C”, or in various other programming languages. Software embodiments of the present invention do not depend on implementation with a particular programming language. In addition, portions of program code may execute entirely on one or more data processing systems.

The present invention is preferably practiced within a client/server programming environment. As is known by those skilled in this art, client/server is a model for a relationship between two computer programs in which one program, the client program, makes a service request from another program, the server program, which fulfills the request. Relative to the Internet, a Web browser is a client program that requests services (the sending of Web pages or files) from a Web server (which technically is called a Hypertext Transport Protocol or HTTP server) in another computer somewhere on the Internet.

A preferred implementation of the present invention utilizes the Application Service Provider (ASP) model. As is understood by those of skill in the art, an ASP is an entity that offers individuals and enterprises access over the Internet (or other communications network) to applications and related services that would otherwise have to be located in local computers and/or devices.

As is known to those with skill in this art, client/server environments may include public communications networks, such as the Internet, and private communications networks often referred to as “intranets” and “extranets.” The term “Internet” shall incorporate the terms “intranet” and “extranet” and any references to the Internet shall be understood to mean a communications network of any type, including intranets and/or extranets.

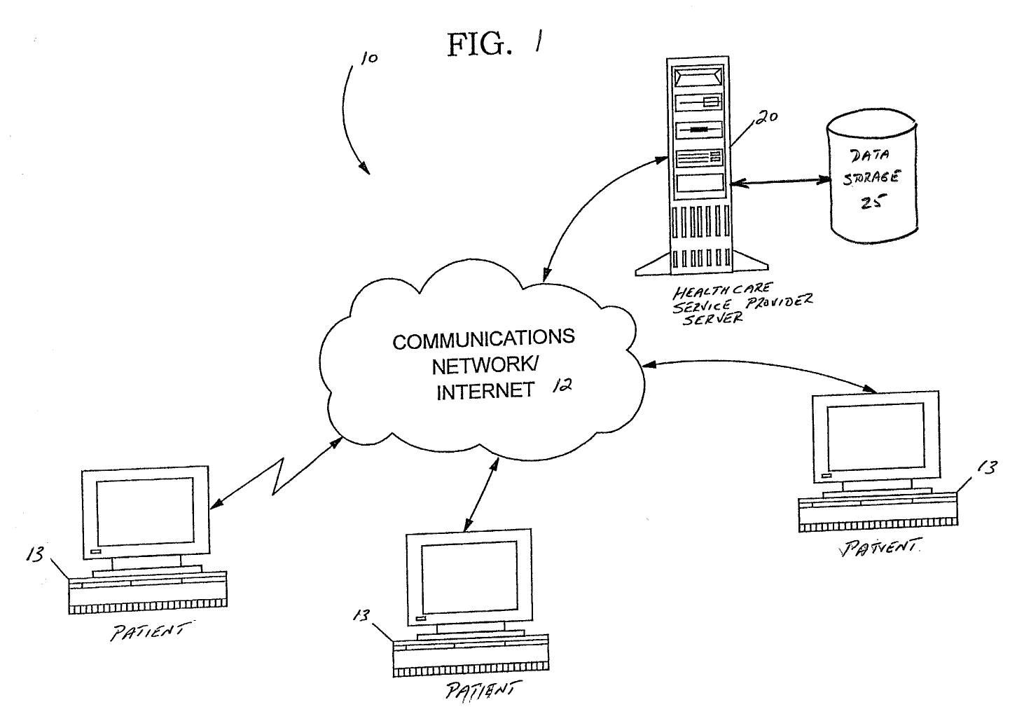

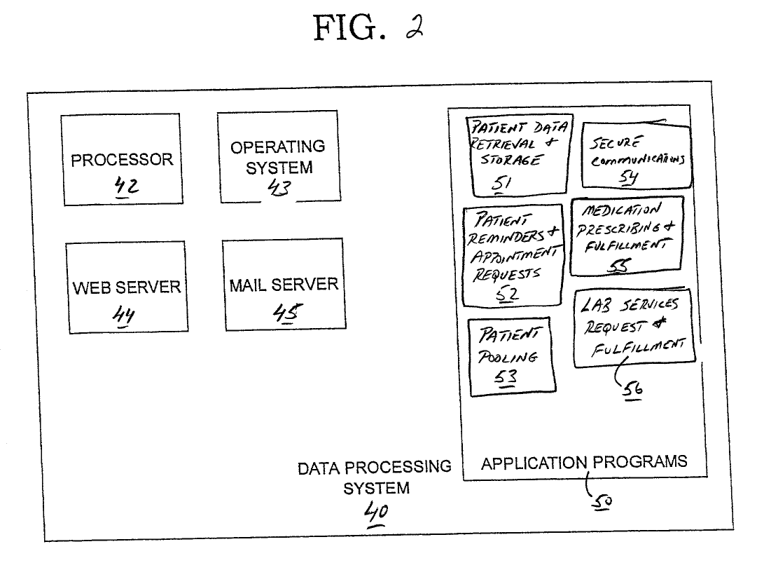

FIG. 1 illustrates an exemplary system 10 for facilitating one-to-one communications between providers of professional services and remotely located clients in a secure environment. The illustrated system 10 is associated with providing healthcare services to remotely located patients; however, it is understood that embodiments of the present invention are not limited to the healthcare industry. Embodiments of the present invention may be utilized by legal service providers, technical service providers, financial services providers, etc.

The illustrated system 10 allows a patient to conduct a “Virtual Office Visit” with a healthcare provider and receive an on-line diagnosis and/or treatment for one or more medical conditions. Communications between patient and healthcare provider are provided in a secure environment. The term “healthcare provider”, as used herein is intended to include physicians, nurses, nurse practitioners, physician assistants, pharmacists, chiropractors, dentists, etc.

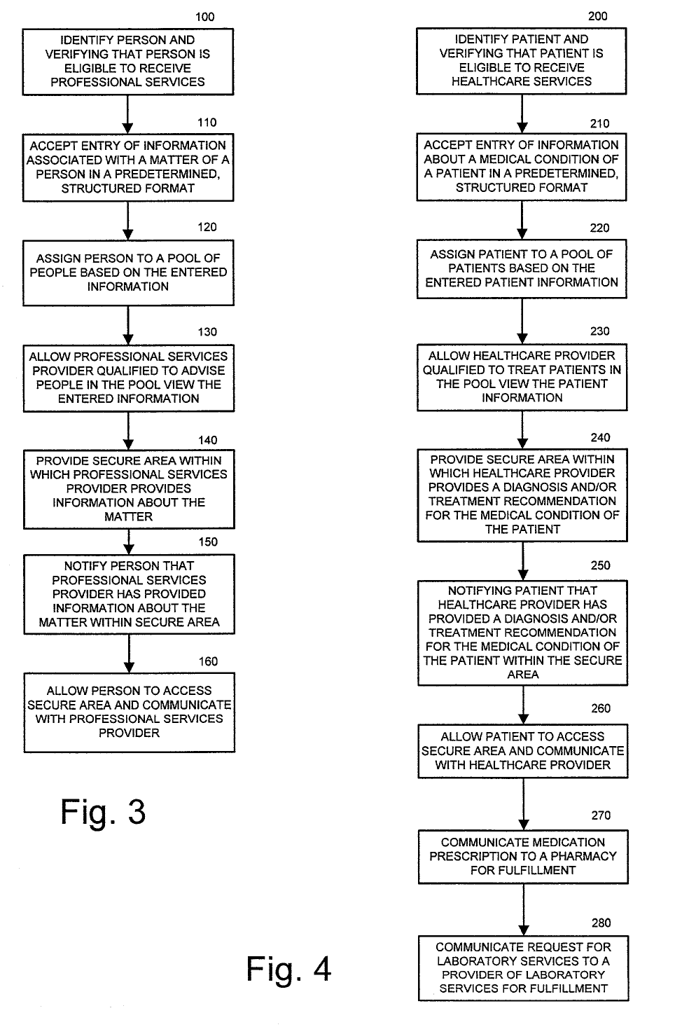

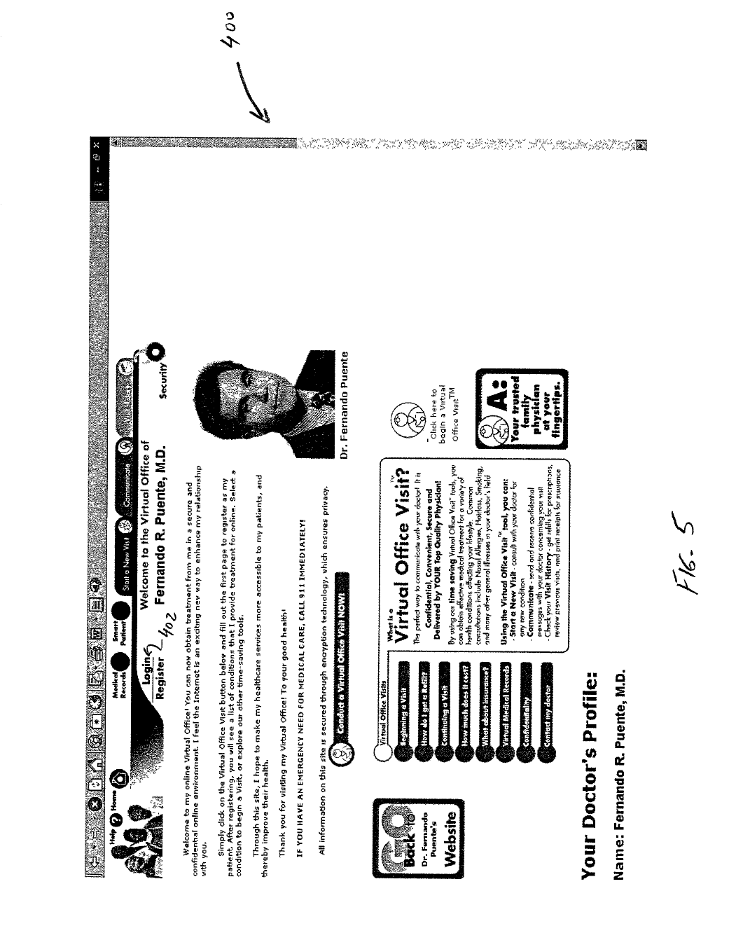

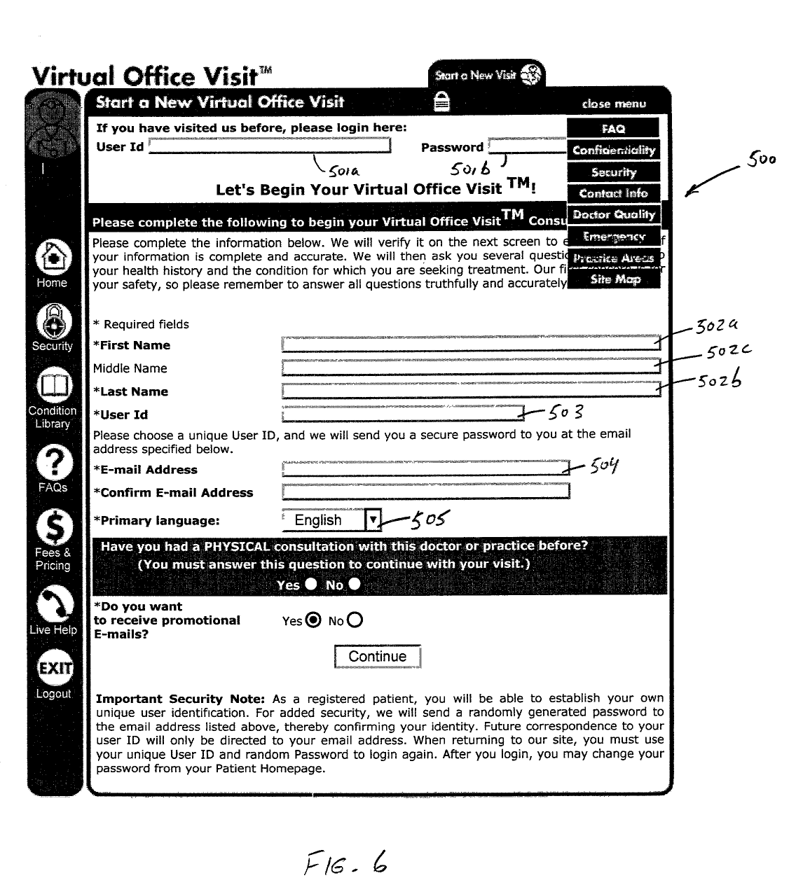

The illustrated system 10 includes a server 20 that is connected to a communications network 12 (e.g., the Internet), a plurality of client devices 13, 13′ that are also connected to the communications network 12, and data storage 25. Exemplary patient client devices 13, 13′ include, but are not limited to, personal computers, wireless communications devices, personal digital assistants (PDAs), hand-held computers, Internet-ready phones, and WebTVs. In addition, devices such as WebCams and/or other digital intake devices such as digital scales, thermometers, and various clinical intake devices may be utilized to communicate images and other data to the server 20. Patient client devices according to embodiments of the present invention may be directly connected to the communications network 12 (e.g., client device 13) or may communicate with the communications network 12 wirelessly (e.g., client device 13′). The server 20 is configured to implement at least the operations described below with respect to FIGS. 3-4.

Referring to FIG. 2, a block diagram of a data processing system 40 that may be used to implement the server 20 (FIG. 1), according to embodiments of the present invention, is illustrated. The illustrated data processing system 40, includes a processor 42, an operating system 43, a web server 44, a mail server 45, and various application programs 50: patient data retrieval and storage 51, patient reminders and appointment requests 52, patient pooling 53, secure communications (e.g., encrypted data communications) 54, medication prescribing and fulfillment 55, and laboratory services request and fulfillment 56. These applications 50 may execute entirely on the server 20 (or on other data processing systems in communication with the server 20), or partly on the server 20 and partly on a patient's client device 13.

The patient data retrieval and storage application 51 is configured to obtain information from patients in a structured format and to store this information for subsequent use. Exemplary patient information includes, but is not limited to, present medical condition, past medical history, family medical history, previous illnesses and/or procedures, and billing and insurance information.

Preferably, patient information for use in accordance with embodiments of the present invention is stored in, and retrieved from, one or more databases in communication with the server 20. However, other data storage technologies may be utilized without limitation. As is known by those of skill in the art, a database is a collection of data that is organized in “tables.” A database typically includes a database manager that facilitates accessing, managing, and updating data within the various tables of a database. Exemplary types of databases that can be used as data storage 25 to implement embodiments of the present invention include, but are not limited to, relational databases, distributed databases (databases that are dispersed or replicated among different points in a network), and object-oriented databases. Relational, distributed, and object-oriented databases are well understood by those of skill in the art and need not be discussed further herein. Exemplary commercial databases that can be used to implement embodiments of the present invention include, but are not limited to, IBM's DB2® database, Microsoft's SQL server database, and other database products, such as those from Oracle, Sybase, and Computer Associates.

The patient reminders and appointment requests application 52 is configured to send various reminder communications to patients and to allow patients to make appointment requests for visits with a healthcare provider.

The patient pooling application 53 is configured to assign patients to a “pool” or queue of patients based on patient-provided information and/or other patient information. For example, a patient may be assigned to a particular pool on the basis of the patient's geographical location, the patient's age, the patient's medical condition, according to the specialty of a professional service provider, the patient's ability and/or willingness to pay, etc. In addition, patient pooling may be based upon various healthcare provider-related factors, such as range of fees healthcare provider is willing to accept, proximity of patients to healthcare provider, volume of patients, previous relationship with patients, and/or contractual commitments. In essence, patient pooling can be based upon various attributes of either a patient or a healthcare provider or both the patient and the healthcare provider.

The communications application 54 is configured to allow healthcare providers to communicate with patients in a secure environment and in compliance with the Health Insurance Portability and Accountability Act of 1996 (HIPAA). For example a healthcare provider diagnoses and/or treats a medical condition of a patient and places a communication for the patient within a secure area. The patient logs-on to the secure area and views the communication. Subsequent communications between the patient and the healthcare provider are performed in a similarly secure manner.

The medication prescribing and fulfillment application 55 allows a healthcare provider to prescribe various medications for treating medical conditions of patients, and allows patients to initiate fulfillment of prescriptions. Similarly, the laboratory services and fulfillment application 56 allows a healthcare provider to request laboratory services for patients and to initiate fulfillment thereof.

Exemplary data processing systems which may be utilized in accordance with embodiments of the present invention include, but are not limited to, Sun Microsystems®, Apple®, IBM®, and IBM®-compatible personal computers and workstations. However, it is to be understood that various computing devices and processors may be utilized to carry out embodiments of the present invention without being limited to those enumerated herein. Exemplary operating systems 43 may include, but are not limited to, LINUX®, UNIX, WINDOWS 98®, WINDOWS 2000®, and WINDOWS NT® operating systems, and PALM OS® and WINDOWS CE® operating systems for handheld devices.

The Web server 44 is configured to handle communications with client devices 13, 13′ (FIG. 1) and other devices that are in communication with the communications network 12. Web servers are well understood by those of skill in the art, and need not be described further herein. Exemplary Web servers that may be utilized in accordance with embodiments of the present invention include Apache, available from the Apache Server Project, http://www.apache.org; Microsoft's Internet Information Server (IIS), available from Microsoft Corporation, Redmond, Washington; and Netscape's FastTrack® and Enterprise™ servers, available from America Online, Inc., Dulles, Va. Other Web servers that may be utilized include, but are not limited to, Novell's Web Server for users of its NetWare® operating system, available from Novell, Inc., San Jose, Calif.; and IBM's family of Lotus Domino® servers, available from International Business Machines Corporation, Armonk, N.Y.

The mail server 45 is configured to send e-mail messages to patients via the communications network 12. Mail servers are well understood by those of skill in the art, and need not be described further herein. Embodiments of the present invention may utilize various types of mail servers. For example, mail servers that send and receive mail, such as the “Sendmail” server utilized by UNIX systems, or “Exchange” server utilized by Microsoft NT® systems, may be utilized.

The present invention will now be described below with reference to block diagrams and/or flowchart illustrations of methods, apparatus (systems) and computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

Referring now to FIG. 3, a flow chart of systems, methods and/or computer program products for providing professional services, according to embodiments of the present invention, will now be described. The term “professional service provider” is intended to include, but not be limited to healthcare service providers, legal service providers, technical service providers, and financial services providers.

Initially, a person who wishes to receive information about a particular matter logs on to the server 20 (FIG. 1) via a client device 13, 13′. The matter may relate to virtually any subject. The server 20 verifies the identity of the person and verifies that the person is eligible to receive professional services (Block 100). For example, the server 20 is configured to verify the identify of the person by comparing location information of the person logging on with known location information. Verification of eligibility to receive professional services may include verifying financial information of the person (e.g., whether the person can pay for the professional services). Verification of eligibility to receive professional services also may include such things as determining whether the person is in a location that allows a service provider to provide the requested service, etc.

Once the identity and eligibility of a person has been verified, the server 20 accepts entry of information associated with a particular matter in a predetermined, structured format (Block 110). This may include allowing the person to select a particular professional services provider for consultation. The server 20 assigns the person to a pool of people based on the entered information and/or other information about the person (Block 120). For example, the person may be assigned to a particular pool on the basis of the person's geographical location, the person's age, a specific aspect of the matter, according to the specialty of a professional service provider, etc. Moreover, a person may be assigned to a particular pool for the selected professional services provider. Typically, persons in each respective pool have at least one common characteristic.

Once placed in a pool, the server 20 allows a professional services provider who is qualified to advise people in the pool view the entered information for the person (Block 130). The term “qualified” is intended to include that the professional services provider is licensed by the appropriate and relevant jurisdictions to advise people in a particular matter. The term “qualified” is also intended to include that the professional services provider is authenticated (e.g., that the identity of the professional services provider is verified). Exemplary means for authentication include, but are not limited to, password and id, public key infrastructure mechanisms and techniques, biometrics, smart cards, etc.

The server 20 provides a secure area, accessible by the person, within which the professional services provider can provide information about the matter (Block 140). The server 20 then notifies the person that a professional service provider has responded to the inquiry and that the information can be viewed within the secure area (Block 150).

The server 20 allows the person to access the secure area via a client device, view the information provided by the professional services provider, and communicate iteratively or in real time with the professional services provider in a secure manner (Block 160). Because communications between the person and the professional services provider are not performed via an e-mail system, the communications are secure and not susceptible to viewing or interception by others.

Referring now to FIG. 4, a flow chart of systems, methods and/or computer program products for a specific implementation of the present invention for the healthcare industry will be described. This embodiment of the present invention involves a virtual office visit wherein physicians and other healthcare providers can conduct on-line, one-on-one consultations with their patients and develop corresponding treatment plans that may result in a prescription medication. Prescriptions may be filled through various on-line pharmacies or through traditional “bricks and mortar” pharmacies.

Initially, a patient who wishes to make a virtual office visit with a healthcare provider logs on to the server 20 via a client device 13, 13′. The server 20 verifies the identity of the patient and verifies that the patient is eligible to receive healthcare services provided via the server 20 (Block 200). For example, the server 20 is configured to verify the identity of the patient by comparing location information of the person logging on with known location information. Verification of eligibility to receive healthcare services may include verifying financial information of the patient (e.g., whether the person can pay for the professional services). Verification of eligibility to receive healthcare services also may include such things as determining whether the patient is in a location that allows a healthcare provider to provide the requested service, etc.

Once the identity and eligibility of a patient has been verified, the server 20 accepts entry of information about a medical condition of the patient in a predetermined, structured format (Block 210). The patient may also be provided with the opportunity to select a particular healthcare provider for consultation. In addition, the patient may be allowed to upload various information including, but not limited to, digitized X-rays, MRIs, EKGs, and the like. Patient information is stored in a secure and confidential medical record associated with the patient.

The server 20 assigns the patient to a pool of patients based on the entered information and/or other patient information (Block 220). For example, the patient may be assigned to a particular pool on the basis of the patient's medical condition, geographical location, age, and/or according to the specialty of a healthcare provider, etc. For example, patients having the medical condition of “hair loss” may be assigned to a particular pool. For patients who selected a particular healthcare provider for consultation during the virtual office visit, the server 20 may assign the patient to a pool for the selected healthcare provider.

Once placed in a pool, the server 20 allows a healthcare provider who is qualified to treat patients in the pool view the entered information for the patient (Block 230). The term “qualified” is intended to include that the healthcare provider is licensed by the appropriate and relevant jurisdictions to treat patients in a particular pool. Healthcare providers are subject to many laws and regulations governing various aspects of health care, both on the municipal, state and federal level. Exemplary laws and regulations include, but are not limited to, licensure, medical records, informed consent, confidentiality, licensure exceptions, exclusions and exemptions, and disciplinary laws. Moreover, healthcare providers practicing in more than one legal jurisdiction (e.g., two or more states) need to be cognizant of the laws and regulations governing health care in each jurisdiction. Embodiments of the present invention allow only healthcare providers who satisfy regulations at all relevant levels to treat patients within a particular pool.

The term “qualified” is also intended to include that the healthcare provider is authenticated (e.g., that the identity of the healthcare provider is verified). Exemplary means for authentication include, but are not limited to, password and id, public key infrastructure mechanisms and techniques, biometrics, smart cards, etc.

The server 20 provides a secure area, accessible by the patient, within which the healthcare provider can provide a diagnosis and/or treatment recommendation for the medical condition of the patient (Block 240). The server 20 then notifies the patient that the healthcare provider has responded to the patient's inquiry and that the healthcare provider's diagnosis and/or treatment recommendation (or other communication) can be viewed within the secure area (Block 250). The server 20 allows the patient to access the secure area via a client device, view the healthcare provider's diagnosis and/or treatment recommendation, and communicate iteratively or in real time with the healthcare provider in a secure manner (Block 260).

According to embodiments of the present invention, if the healthcare provider prescribed medication for the person as a part of a treatment recommendation, the server 20 is configured to communicate the medication prescription to a pharmacy for fulfillment (Block 270). This may include initiating a telephone call to a pharmacy, sending an electronic communication (e.g., an e-mail message, fax or industry standard data packet) to a pharmacy, and/or communicating with an on-line pharmacy. According to embodiments of the present invention, if the healthcare provider requested laboratory services to be performed on the patient, the server 20 is configured to communicate the request for laboratory services to a laboratory for fulfillment (Block 280). This may include initiating a telephone call to a laboratory, and/or sending an electronic communication (e.g., an e-mail message, fax or industry standard data packet) to a laboratory. In addition, the server 20 may be configured to communicate the results of the laboratory services to the patient (e.g., secure area, e-mail, etc.).

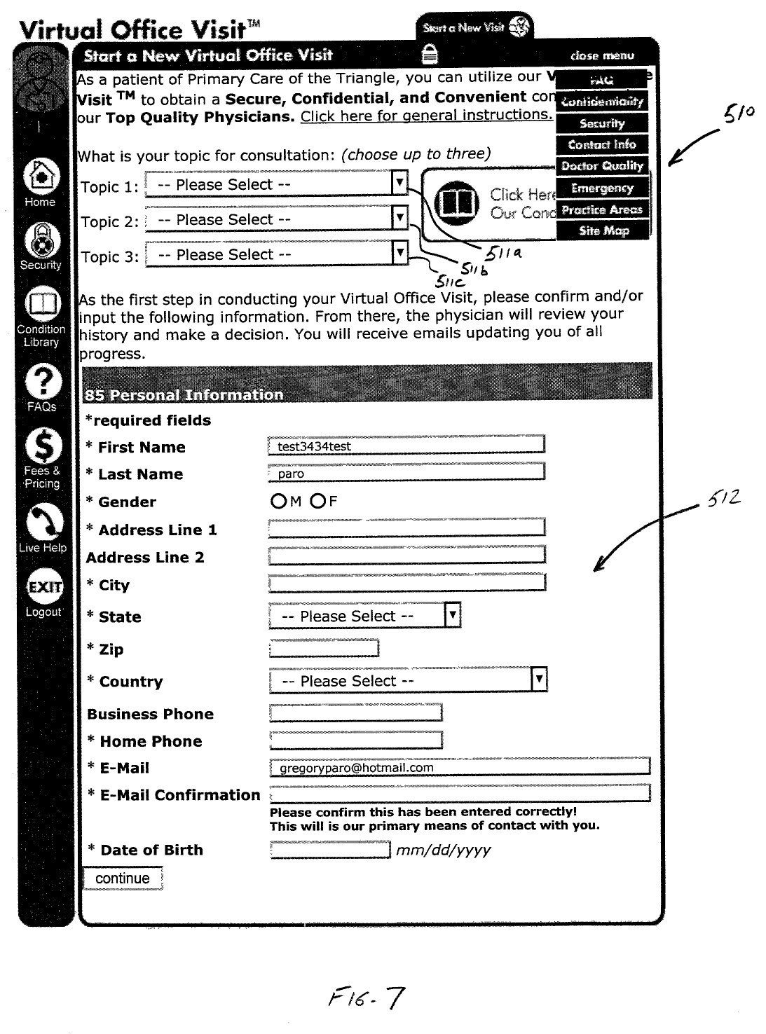

Referring now to FIGS. 5-11, a virtual office visit wherein a patient requests medical counseling and/or treatment from a healthcare provider, will be described in detail. Using a client device and a client program, such as a browser, a patient accesses a “virtual office” of a healthcare provider. For example, as illustrated in FIG. 5, a patient accesses the Web site of a physician. Via the displayed Web page 400 for the physician, the patient activates the “Login” icon 402 to initiate a virtual office visit.”

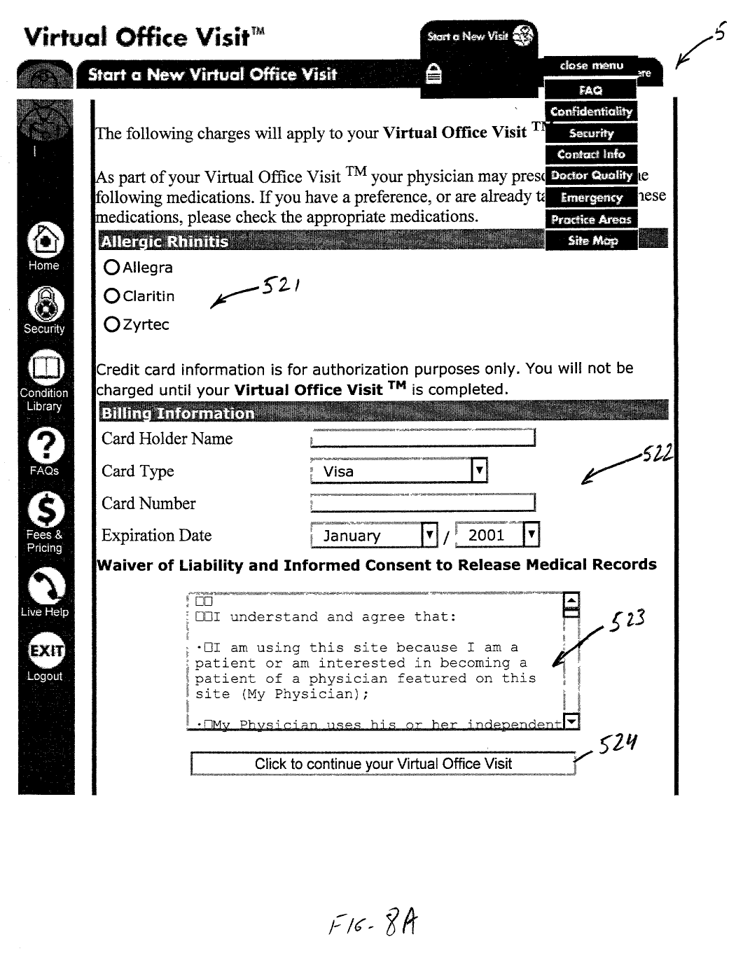

In response to activation of the “Login” icon 402 of FIG. 5, a patient log-in screen 500 is presented to a patient, as illustrated in FIG. 6. If the patient is an existing patient of the healthcare provider (i.e., the patient is a registered user of the “virtual office”), the patient can enter a user ID and password in fields 501a, 501b and proceed. However, if the patient is a new patient (i.e., the patient is not a registered user of the “virtual office”), the patient is required to provide information in the various fields of log-in screen 500. For example, in the illustrated log-in screen 500, a patient is required to enter information in respective fields, such as first name 502a, last name 502b, middle name 502c, user ID 503, e-mail address 504, and primary language 505. Once registered, the patient receives a password to be used in later visits to the healthcare provider's “virtual office.” According to embodiments of the present invention, patients may be allowed to change/modify assigned passwords.

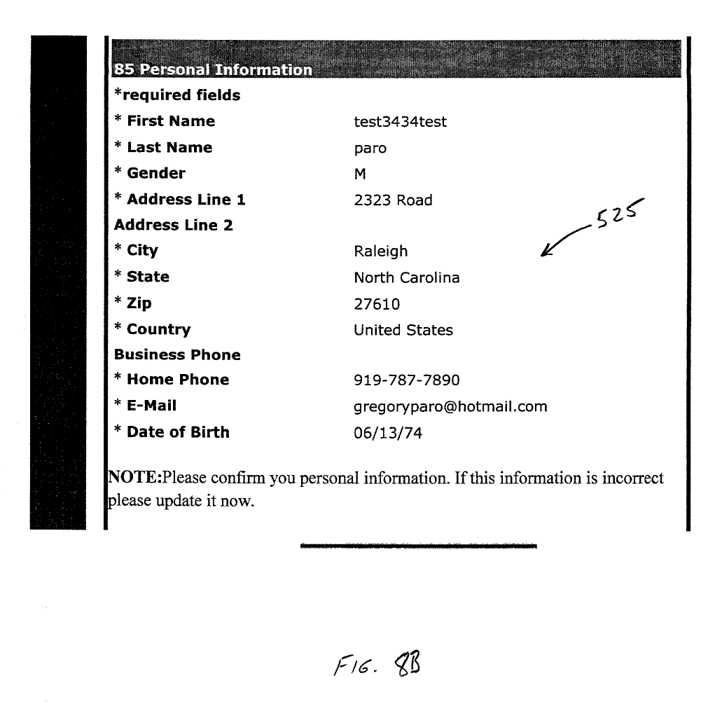

Once the patient is registered, the patient is presented with a screen 510 (FIG. 7) in which the patient provides information about this visit. The patient selects a medical condition topic for the consultation from one or more of the pull down menu boxes 511a, 511b, 511c. Personal information for the patient is retrieved from storage and displayed within the fields in the portion of the screen 510 generally referred to as 512.

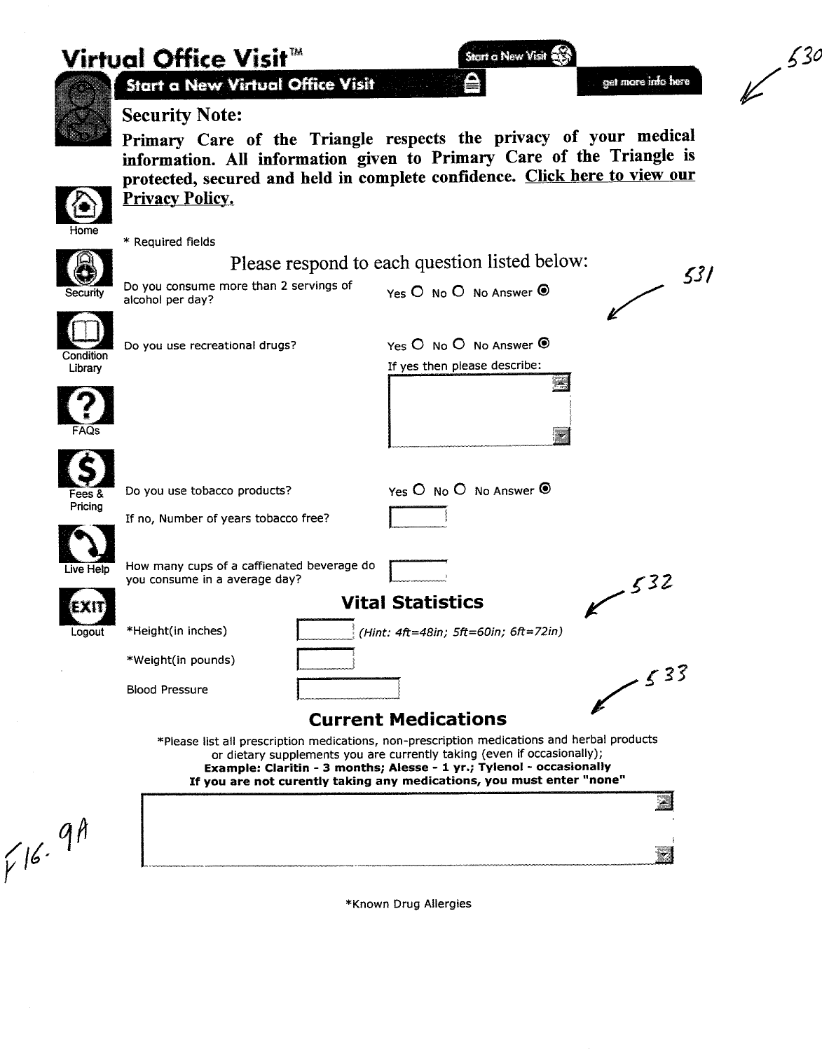

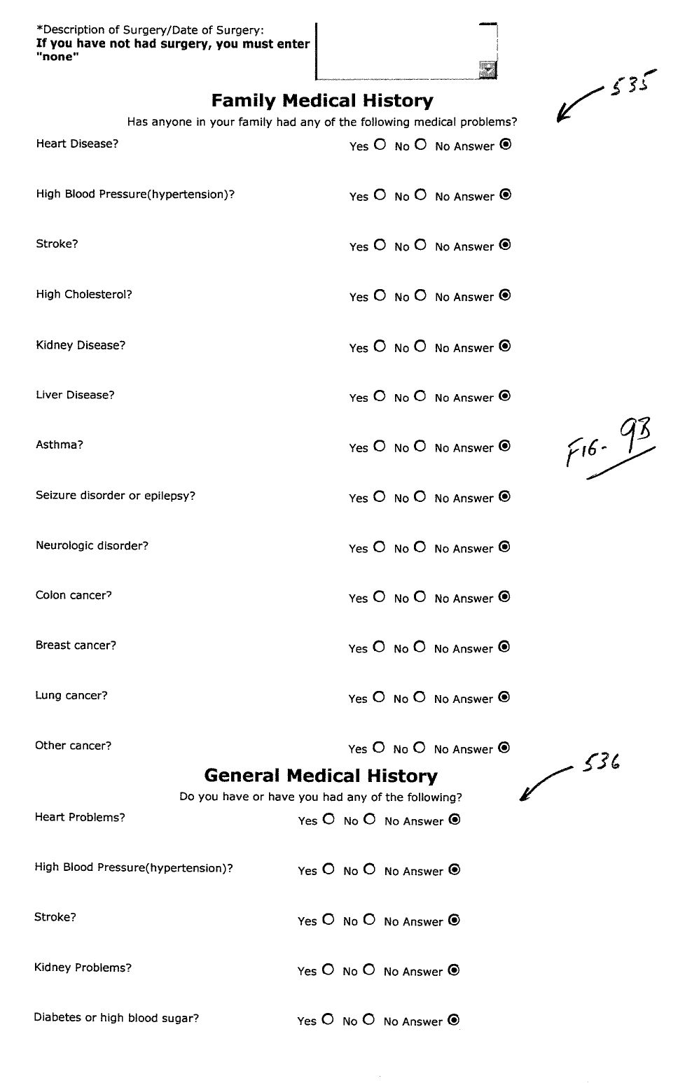

The next screen presented to the patient is screen 520 of FIG. 8. In screen 520, the patient is prompted to select specific prescription medication they would like to use for treating their medical condition from a list 521 of medications. Once the patient has selected a medication, the patient is prompted for payment information in the fields in the portion of screen 520 generally referred to as 522. In the illustrated screen 520, the patient is prompted for credit card information. However, information about various methods of payment may be obtained from the patient according to embodiments of the present invention. Moreover, a third party, such as CyberCash, Inc. (2100 Reston Parkway, Reston, Va.) and LINX Systems (Atlanta, Ga.) may be involved in verification of payment information provided by a patient.

Below the payment information area 522, the patient is presented with an agreement 523 entitled “Waiver of Liability and Informed Consent to Release Medical Records.” If the patient consents to the agreement 523 (e.g., by clicking on the Continue button 524), the patient can continue; otherwise, the patient's visit is terminated.

Also, via screen 520 the patient can preview personal information maintained by the system in the area generally indicated as 525. If there are any discrepancies or changes, the patient can update the information presented in the various fields at this time.

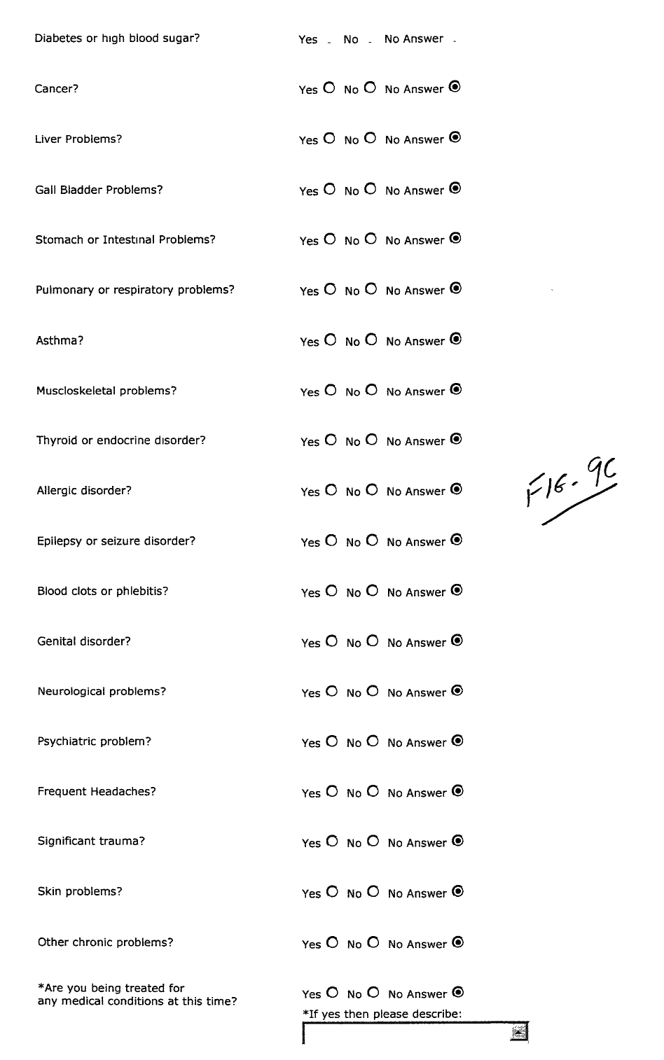

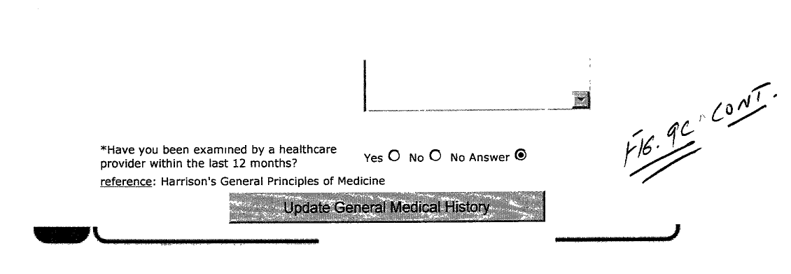

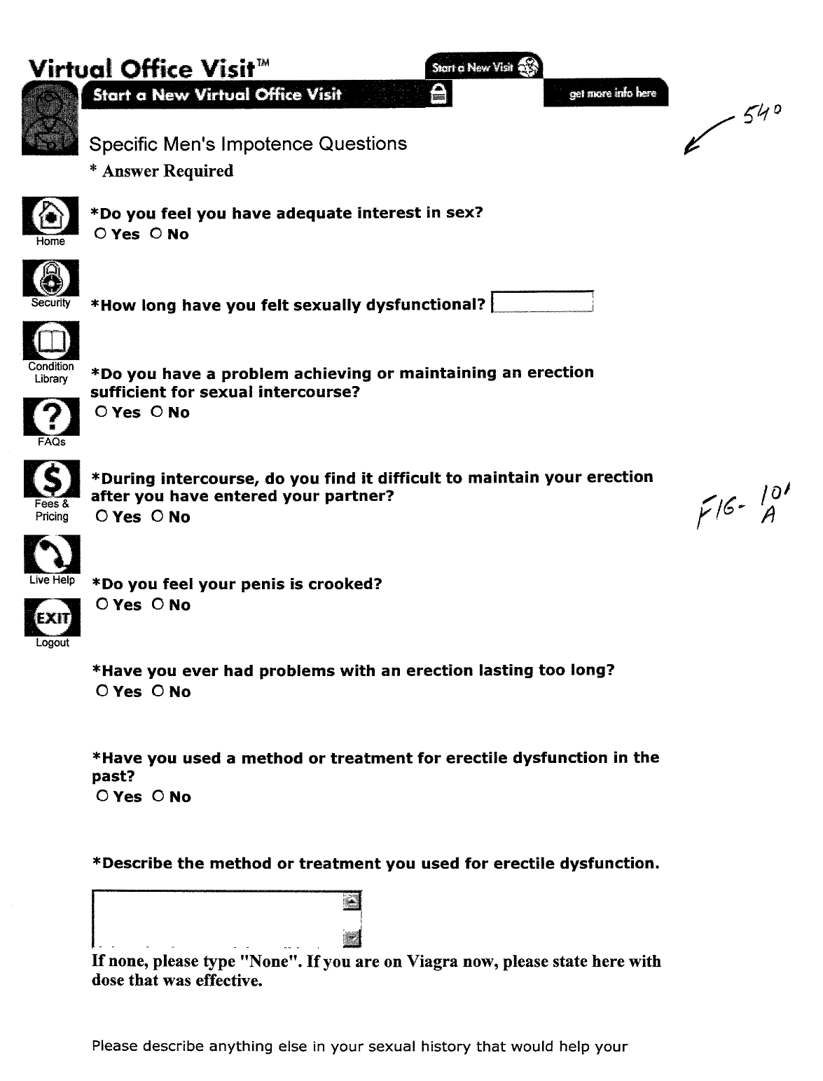

Referring to FIG. 9, the patient continues by providing answers to general medical history questions via screen 530. The patient answers questions related to lifestyle 531, vital statistics 532, current medications the patient is taking 533, surgical history 534, family medical history 535, and general medical history 536.

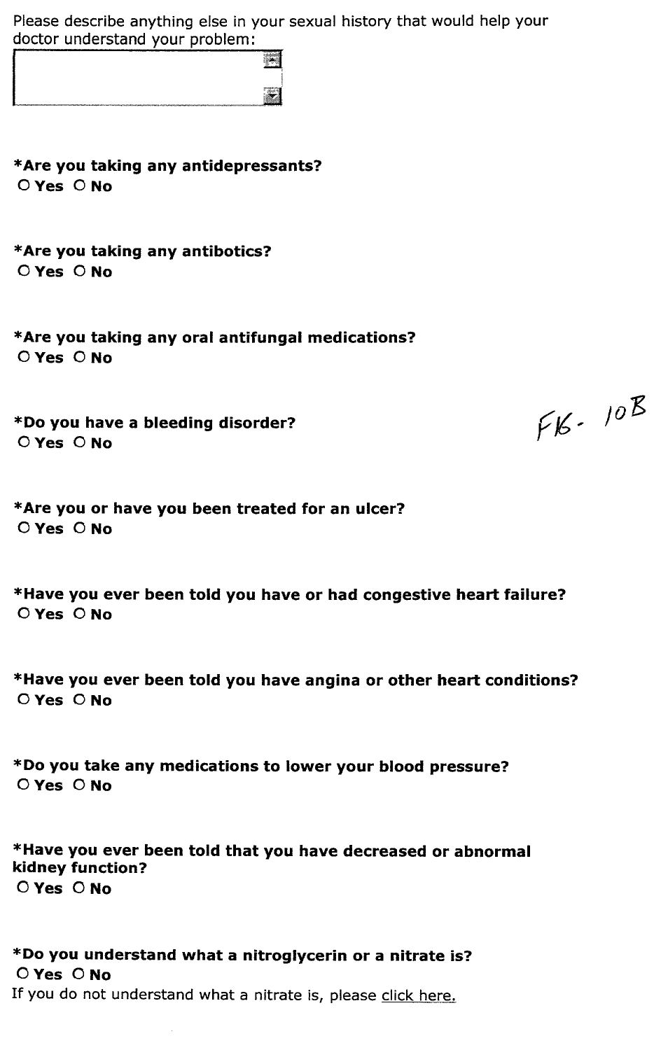

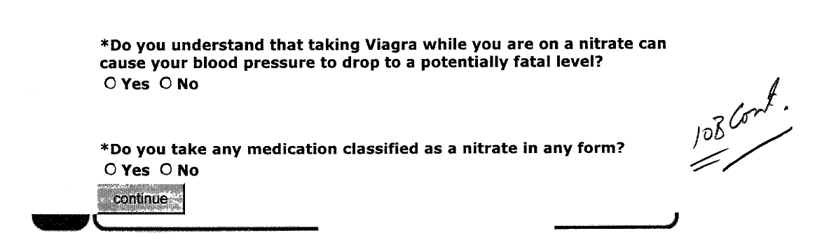

Referring to FIG. 10, the patient continues by providing answers to specific medical questions for the medical condition for which the patient is seeking treatment via screen 540. Screen 540 is a physician-designed template that is specially designed to invoke answers to questions related to the particular medical condition of the patient. The answers provided by the patient allow a healthcare provider to determine whether or not the patient will respond favorably to medication or other treatment plan that the healthcare provider would generally provide to treat the patient's medical condition.

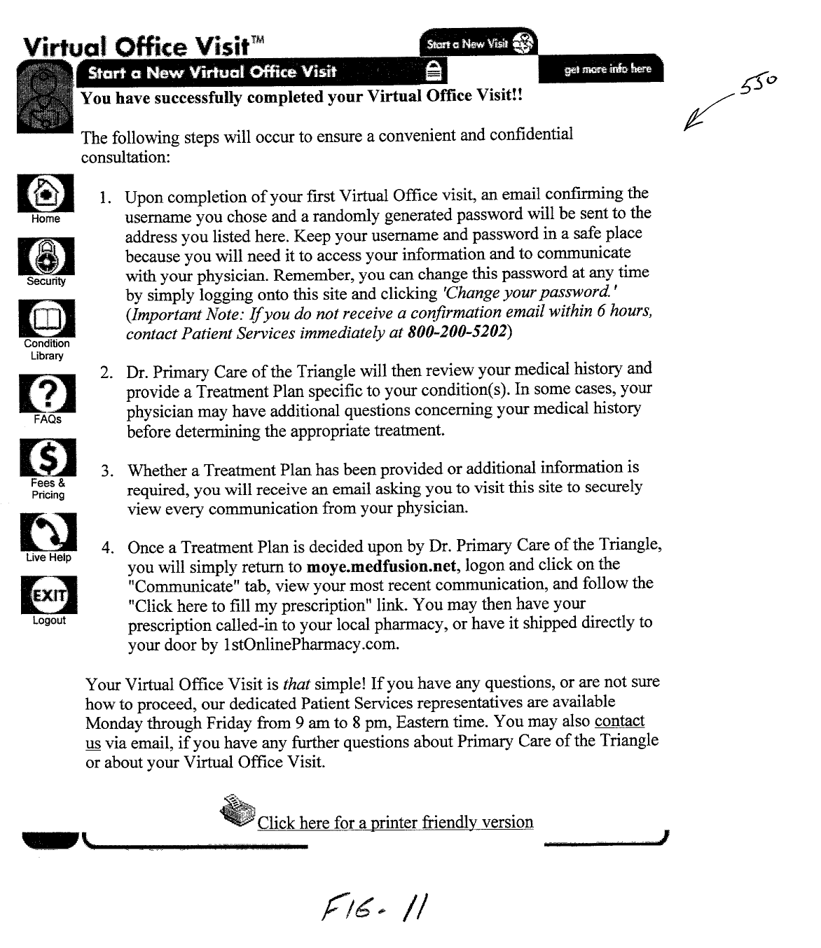

Referring to FIG. 11, after providing information in above-described screens 500-540, the patient is presented with screen 550 which notifies the patient that the patient has successfully completed a virtual office visit. Moreover, the patient is notified that the secure, on-line consultation will be reviewed by a healthcare provider within a specified period of time (e.g., within the next 12-24 hours), and that the patient will be receiving an e-mail message, or other communication, that will prompt the patient to log-in to a secure area to view a communication with a healthcare provider. All of the information collected from a patient via the various screens described above is stored within one or more secure databases, as would be understood by those skilled in the art.

In addition, the patient may be allowed to print a receipt or record of the virtual office visit (e.g., for insurance purposes). The patient may also be given the opportunity to log-on to the secure area at a later time to print a record of the virtual office visit.

Each healthcare provider, according to embodiments of the present invention, has a profile that specifies the healthcare provider's field of healthcare, as well as other factors that are considered when assigning the healthcare provider to a pool of patients, such as licensing issues. Each healthcare provider is designated as acceptable to provide healthcare services to a particular pool of patients based upon this profile.

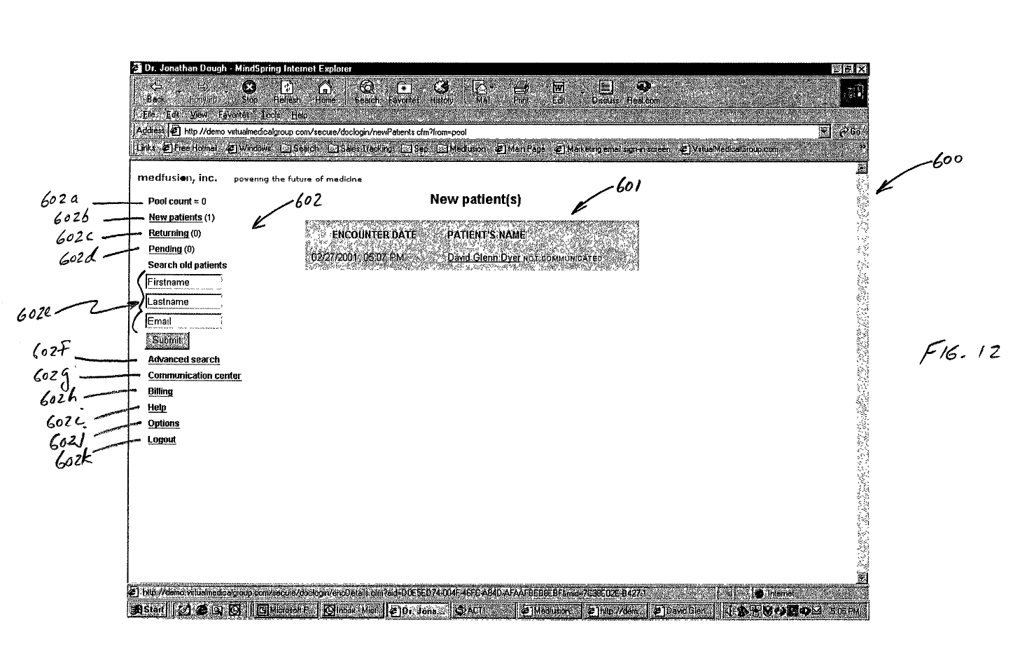

Referring now to FIGS. 12-17, the healthcare provider portion of a virtual office visit will be illustrated. If any new patients have completed a virtual office visit, as described above, they will appear in the illustrated screen 600 of FIG. 12 under the “New Patients” heading 601 for a healthcare provider that is allowed to service patients in the particular pool, based upon his/her profile. Information included under the illustrated New Patients heading 601 includes encounter date and time, patient name, whether or not the patient has been communicated with, and what physician group or individual the patient belongs to.

Adjacent the New Patients heading 601 are a plurality of navigation links indicated generally as 602. The first link “Pool Count” 602a indicates how many patients are currently in the pool for which the particular healthcare provider is authorized to diagnose and treat patients as well as patients that have selected this physician to perform services for them. For example, a patient who resides in North Carolina and has the medical condition of “male impotence”, will be placed in a healthcare provider's pool who fits this patient's profile. The next link “New Patients” 602b, upon activation, presents a listing of new patients. The healthcare provider can select a patient from the list to initiate a secure consultation with the particular new patient.

The next link “Returning” 602c, upon activation, presents a list of returning patients. The healthcare provider can select a patient from the list to initiate a secure consultation with the particular returning patient. Consultations with returning patients are conducted in a similar manner as consultations with new patients. Returning patients generally have received treatment, for example, in the form of prescription medication, and are seeking to continue their treatment. The system typically asks returning patients specific questions regarding how they reacted to previously prescribed medication or treatment plan.

The next link “Pending” 602d, upon activation, presents a listing of patients who are pending for treatment. Pending patients are patients with whom the healthcare provider has communicated with and from whom the healthcare provider is awaiting additional information. Typically, the healthcare provider is awaiting the additional information in order to make a decision whether or not to treat the patient with prescription medication or another treatment plan.

Also included in the navigation links 602 of the illustrated screen 600 are search fields, generally indicated as 602e, for use in searching through stored patient information by patient name and/or e-mail address. Additional links included in the illustrated screen 600 are “Advanced Search” 602f, “Communications Center” 602g, “Billing” 602h, “Help” 602i, “Options” 602j, and “Logout” 602k.

Advanced Search 602f, upon activation, allows a healthcare provider to perform various additional searches of stored patient information. Communications Center 602g, upon activation, allows the healthcare provider and a patient to communicate securely about the consultation. Billing 602h, upon activation, allows the healthcare provider to access and view various accounting and billing functions and data. Help 602i, upon activation, allows the healthcare provider to obtain answers to various questions. Options 602j, upon activation, allows the healthcare provider to edit, delete, or create custom messages for patients. Logout 602kterminates a session, as would be known to those skilled in the art.

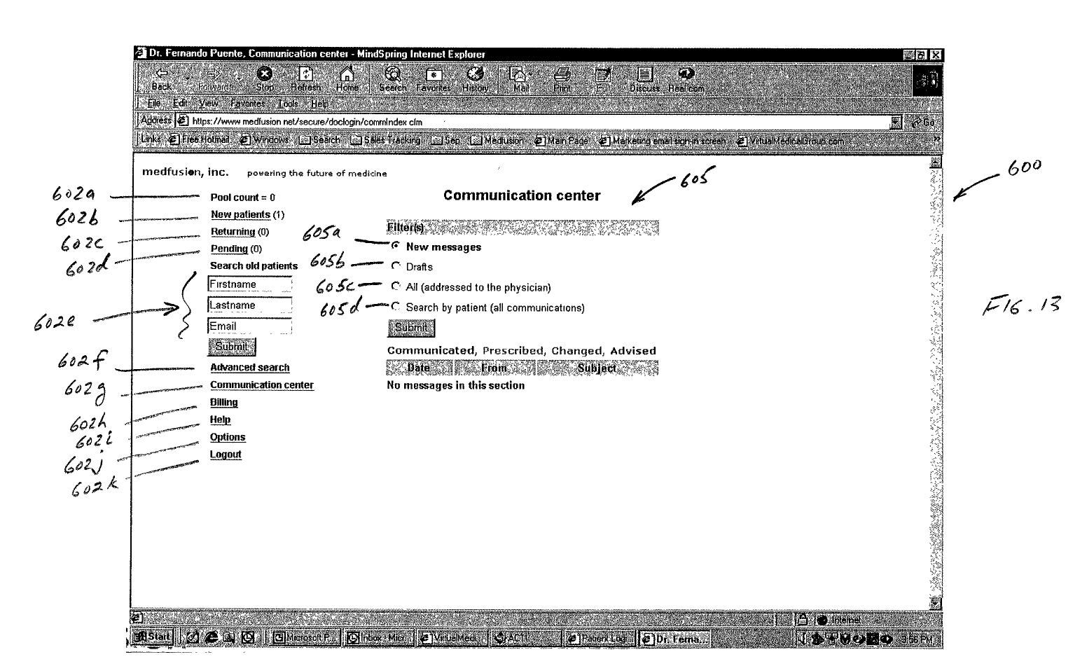

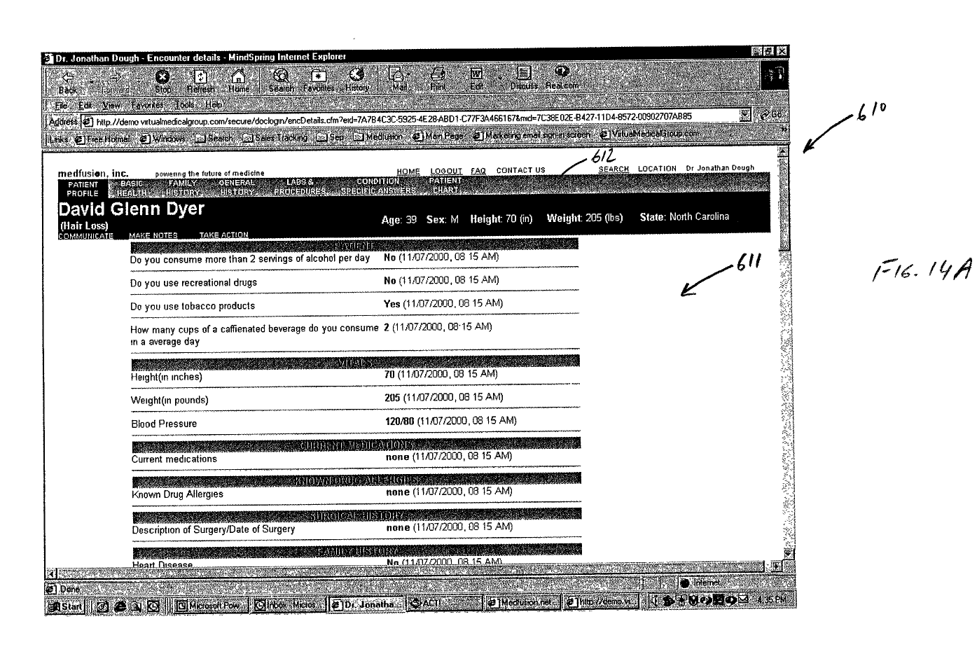

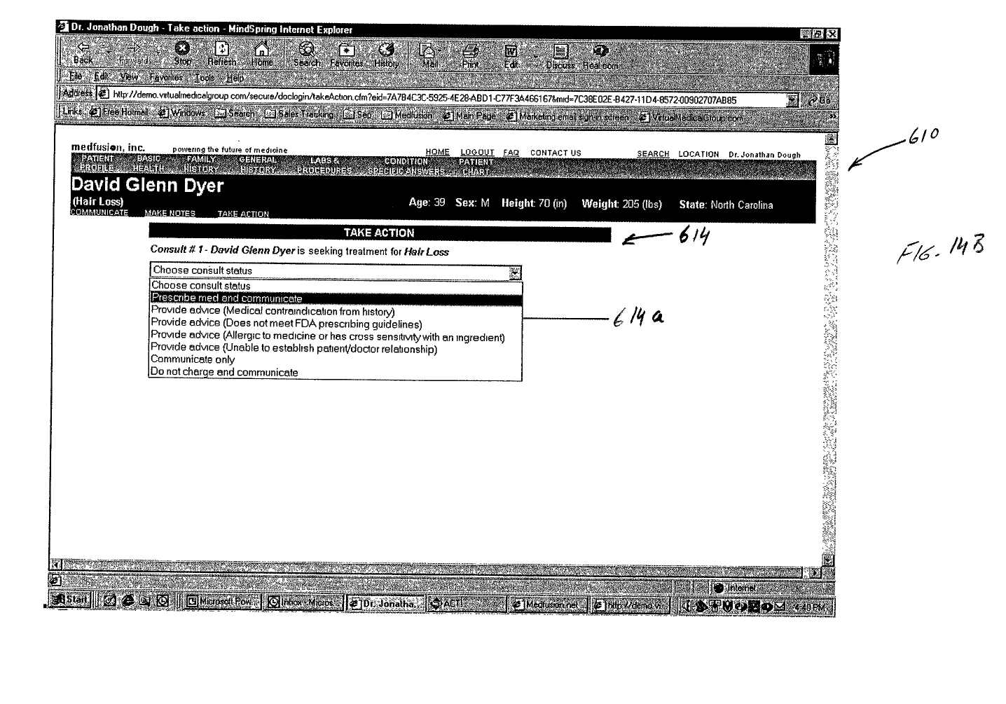

Referring to FIG. 13, screen 600 is illustrated with the an area entitled “Communications Center”, indicated as 605, displayed therein as a result of activation of the link “Communications Center” 602g. In this area, the healthcare provider can view and respond to various patient communications. Radio button 605a allows the healthcare provider to view new communications that have been sent to the healthcare provider from patients or other providers related to a particular patient's medical condition. Radio button 605b allows the healthcare provider to view communications between the healthcare provider, patients, and pharmacists. Radio button 605c allows the healthcare provider to view communications that have been sent to the healthcare provider. In addition, the healthcare provider can search for specific patient communications by using the search function 605d. Upon activation of a patient link under the New Patients heading 601 in screen 600 of FIG. 12, the particular patient's profile is displayed to the healthcare provider as illustrated in screen 610 of FIG. 14A. The illustrated patient profile 611 includes the patient's answers to questions during the virtual office visit, such as “General Medical History” 536 (FIG. 9), “Specific Condition Answers” 540 (FIG. 10), and “Vital Statistics” 532 (FIG. 9). Under the patient's name in the top menu bar 612, the medical condition that the patient would like to have treated is displayed. In the illustrated patient profile 611, the medical condition to be treated is “Hair Loss.” In addition, the illustrated top menu bar 612 displays the patient's age, sex, height, weight, and location. In the illustrated embodiment, the top menu bar 612 is displayed throughout the healthcare provider consultation.

After reviewing the information contained in the patient's profile 611, including the patient's answers to the questions presented during the virtual office visit, the healthcare provider is in a position to determine what form of treatment is best for this patient, including whether or not the patient can receive a prescription medication to treat the medical condition.

Also included in the illustrated screen 610 is a “Take Action” heading 614 (FIG. 14B) which includes a pull-down menu box 614a containing a plurality of selectable actions. From the pull-down menu box 614a, the healthcare provider can prescribe prescription medication and communicate in a variety of ways. For example, when the healthcare provider selects “Prescribe and Communicate” from the pull-down menu box 614a, the healthcare provider has decided that this particular patient is able to take the prescription medication offered to treat the patient's medical condition.

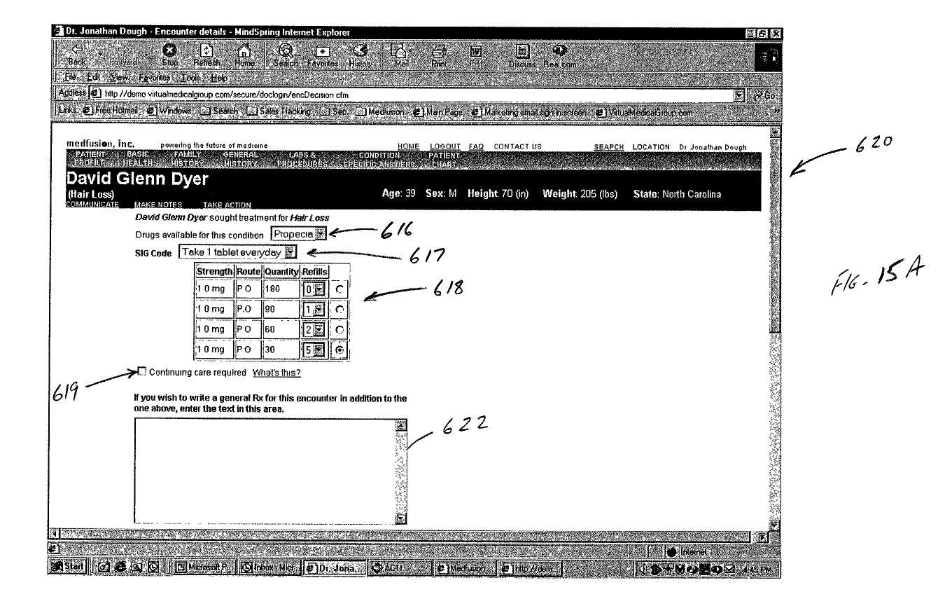

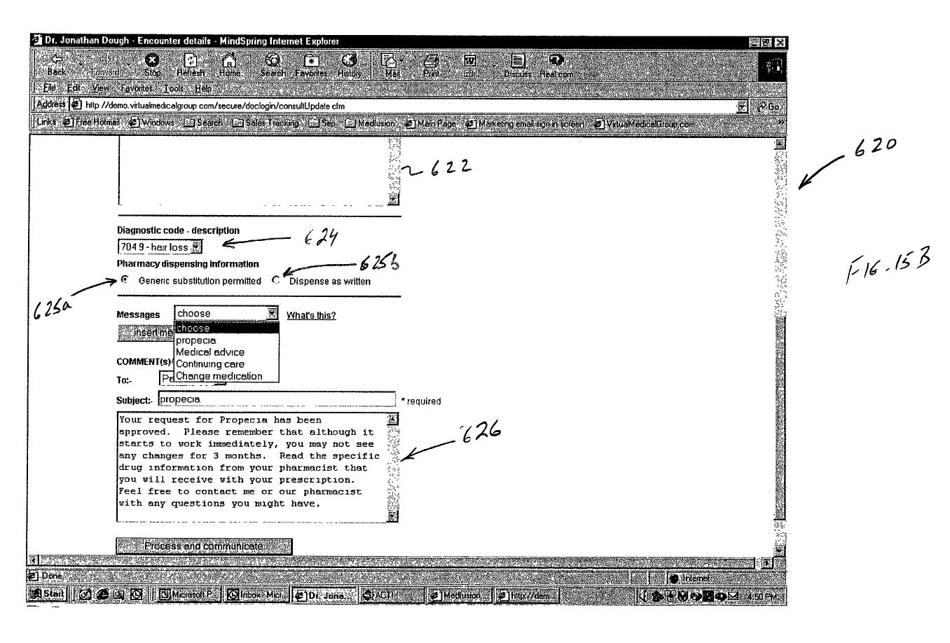

In response to selecting an action from box 614a (FIG. 14B), the healthcare provider is presented with screen 620 (FIG. 15A) that includes a pull-down menu 616 for selecting prescription medication (e.g., Propecia® hair loss medication for hair loss) and a pull-down menu 617 for indicating dosage amounts (e.g., 1 tablet daily). From the same screen 620, the healthcare provider can utilize a table 618 for indicating the amount of the prescription and whether or not the patient will be able to refill the prescription. If the healthcare provider would like the patient to communicate how the patient reacted to the medication, the healthcare provider can activate the “Continuing Care” checkbox 619. Continuing care is an option that the healthcare provider can implement that requires the patient to answer specific questions before subsequent prescriptions will be authorized. According to embodiments of the present invention, these questions can be automatically generated for the patient to answer and the healthcare provider can be notified when the questions are answered by the patient.

In the illustrated screen 620, the healthcare provider also has the option of writing a general prescription via input box 622. Also, the healthcare provider can submit a Diagnostic Code via pull-down menu 624 so that the prescription can be billed to the patient's medical insurance company. Radio buttons 625a, 625b allow the healthcare provider to indicate whether the prescribed medication can have a generic substitution medication 625a, or if the prescription must be filled exactly as prescribed 625b.

The healthcare provider can utilize the communication box 626 in screen 620 to write a message to the patient, or choose a pre-written message on a variety of subjects having to deal with the medication, consumption, or general medical advice.

Referring back to the “Take Action” heading 614 in screen 610 of FIG. 14B, if the healthcare provider does not believe that the patient is a viable candidate for the prescription medication, the healthcare provider can choose an action of communicating to the patient why medication is being refused. As illustrated in box 614a, medication may be refused because of possible contraindications from the patient's medical history, because the patient does not meet Federal Drug Administration prescribing guidelines, because the patient may be allergic to the medication or may have a cross sensitivity with an ingredient, and/or because the healthcare provider may not be able to establish a patient/doctor relationship for various reasons.

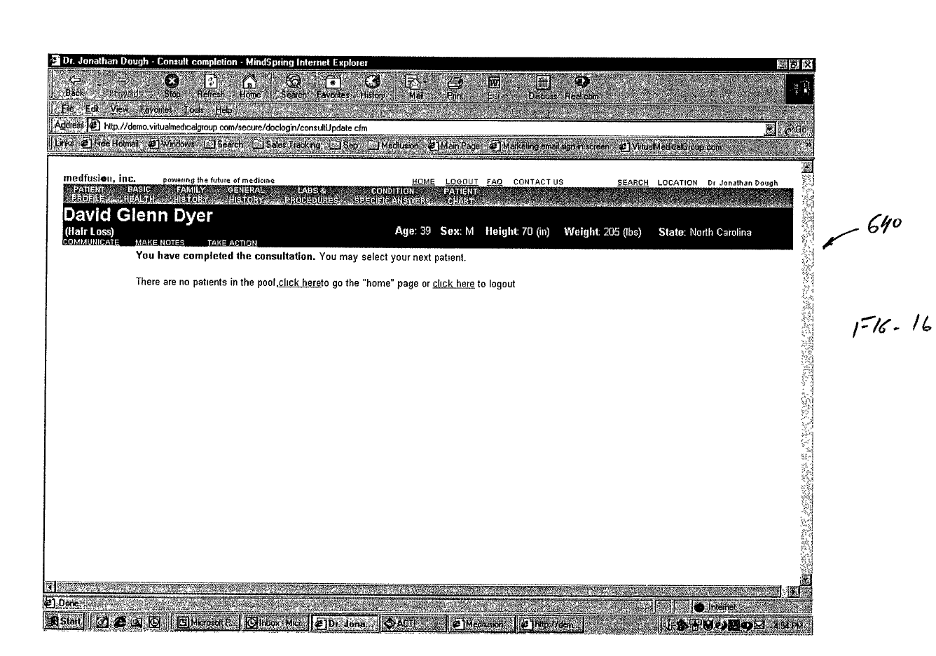

Once the healthcare provider has taken action (e.g., prescribed and communicated or just communicated to the patient), the healthcare provider can now treat another patient. A notification screen 640 (FIG. 16) appears that confirms that the healthcare provider has completed the consultation for this particular patient.

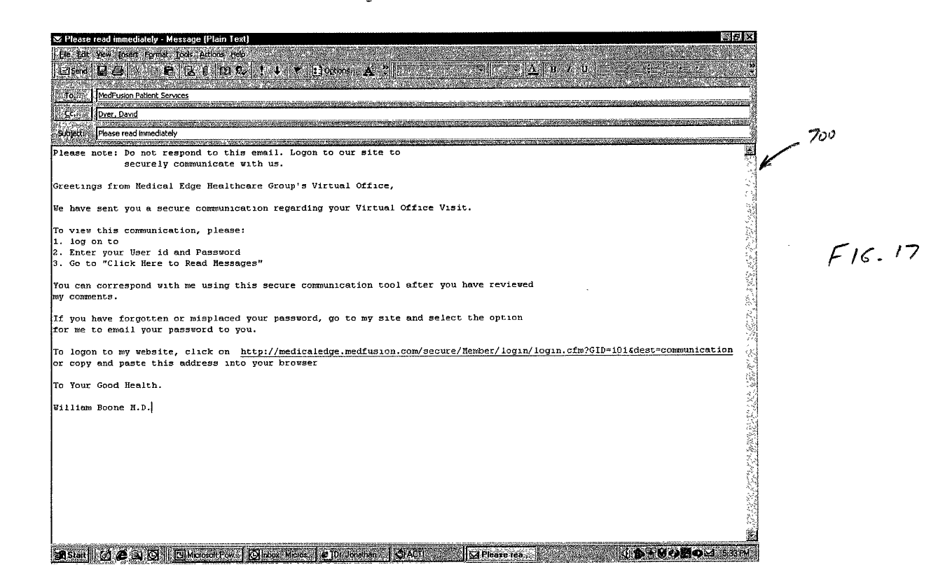

Referring now to FIG. 17, an e-mail message 700 for the patient, prepared on behalf of the healthcare provider by the mail server 45 (FIG. 2), is illustrated. The e-mail message 700 notifies the patient that a secure communication from the healthcare provider has been prepared for the patient in response to the patients virtual office visit. The patient is instructed to log-in to the secure area to view the communication.

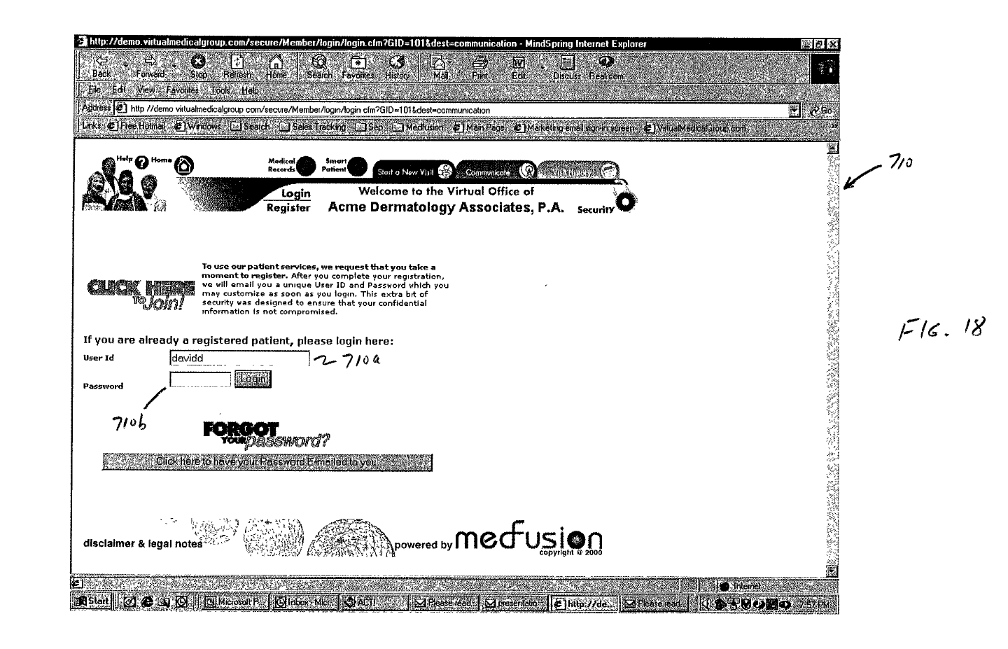

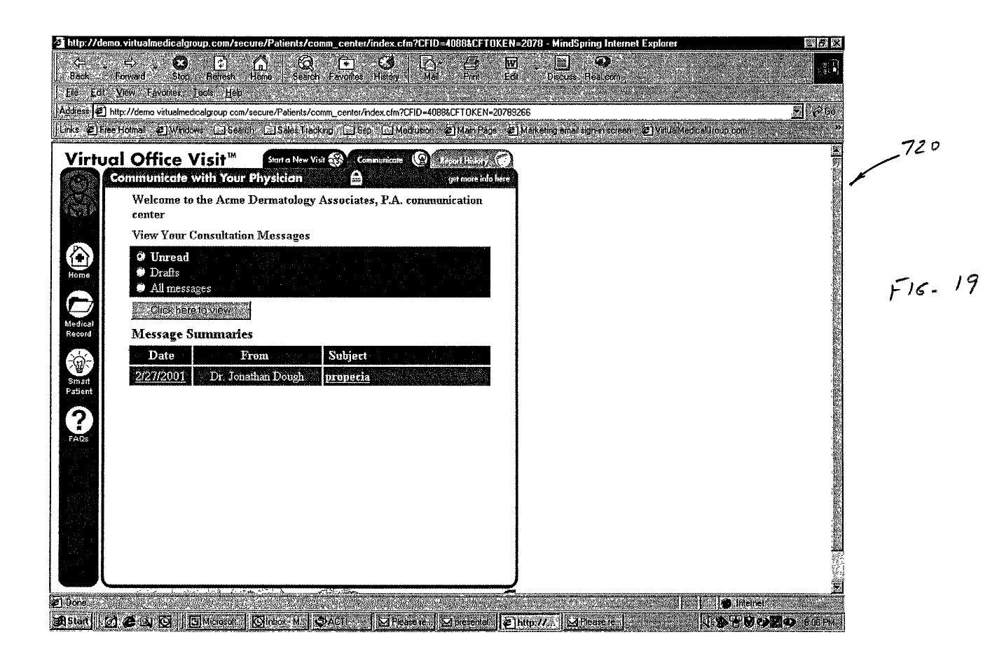

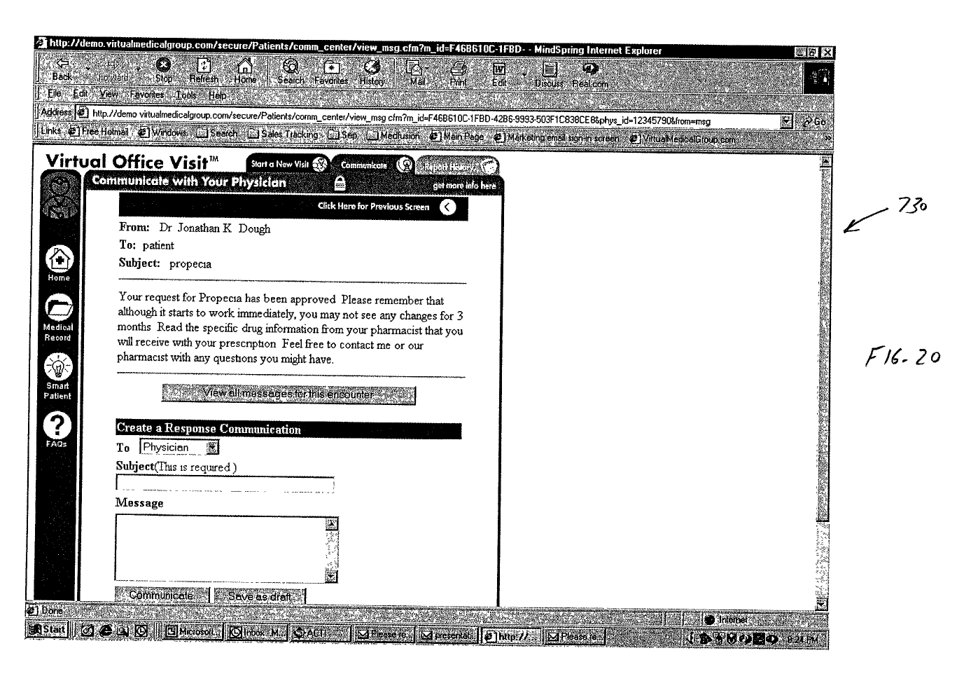

FIG. 18 illustrates an exemplary log-in screen 710 for use by the patient in accessing the secure area. Upon entering a user ID in field 710a, and a password in field 710b, the patient can access the secure area of the healthcare provider as illustrated by screen 720 of FIG. 19. Via screen 720, the patient can read and respond to communications from the healthcare provider. Screen 730 of FIG. 20 illustrates a communication from the healthcare provider that is being viewed by the patient.

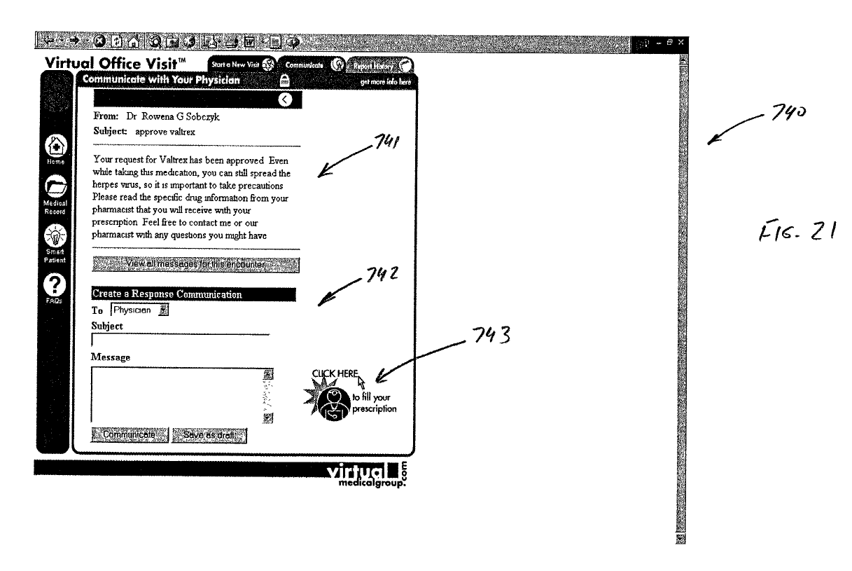

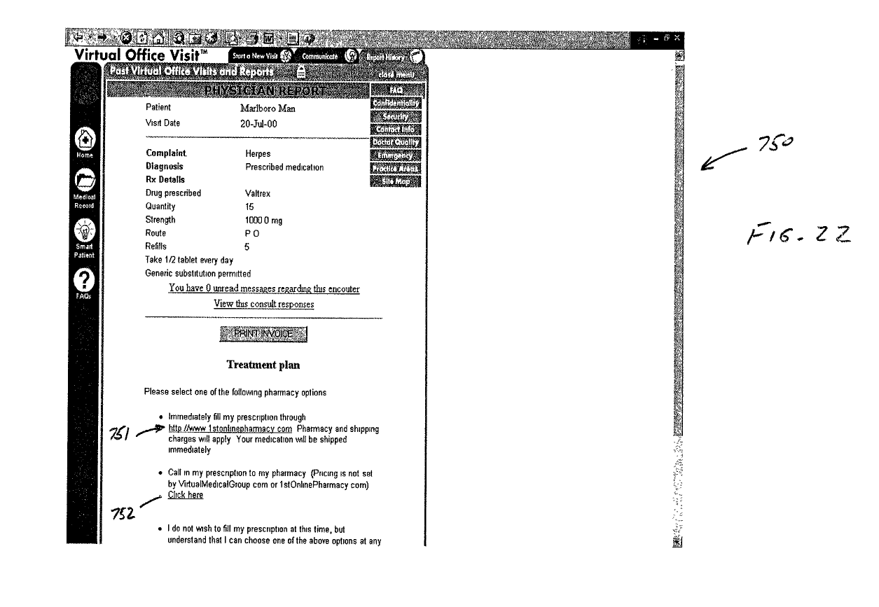

Referring to FIG. 21, screen 740 illustrates a message 741 from a healthcare provider indicating that a patient's request for prescription medication as been approved. Healthcare providers may be allowed to customize these responses during setup. The patient can prepare a response to the communication in the area indicated as 742. The patient can activate the link 743 to initiate fulfillment of the prescription. Screen 750 in FIG. 22 illustrates various fulfillment options available to the patient. The patient can activate link 751 to have the prescription fulfilled by an on-line pharmacy. Alternatively, the patient can activate link 752 to have the prescription called in via telephone to a pharmacy.

It is understood that embodiments of the present invention are not limited to the various, illustrated screens described and illustrated herein. Various screens and other user interfaces can be utilized in accordance with embodiments of the present invention.

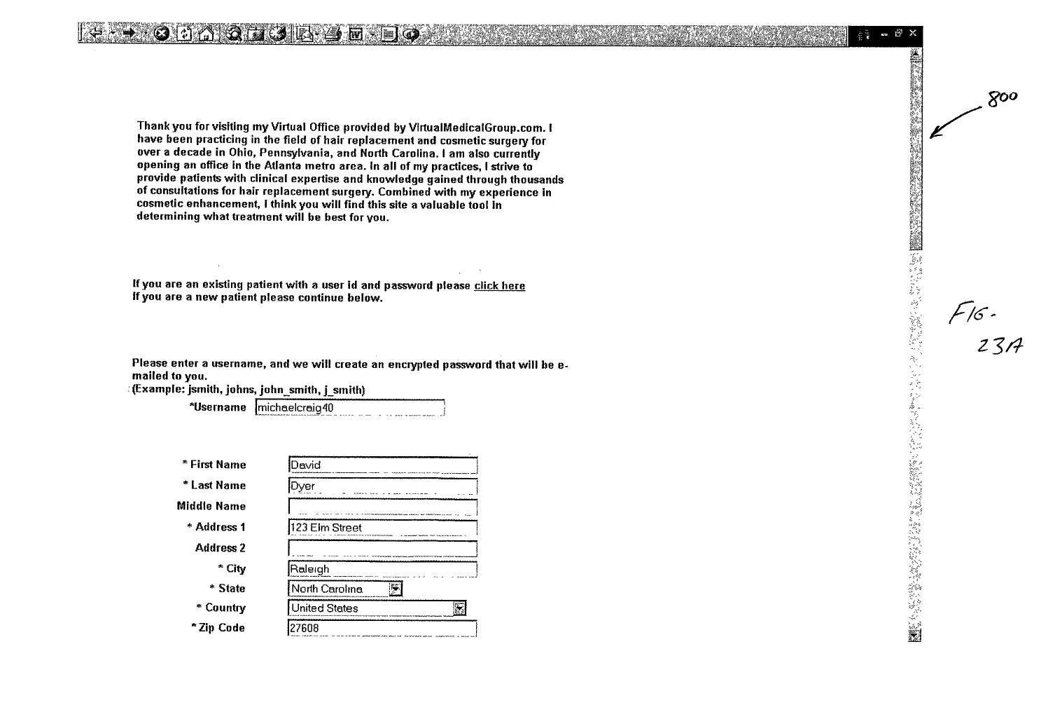

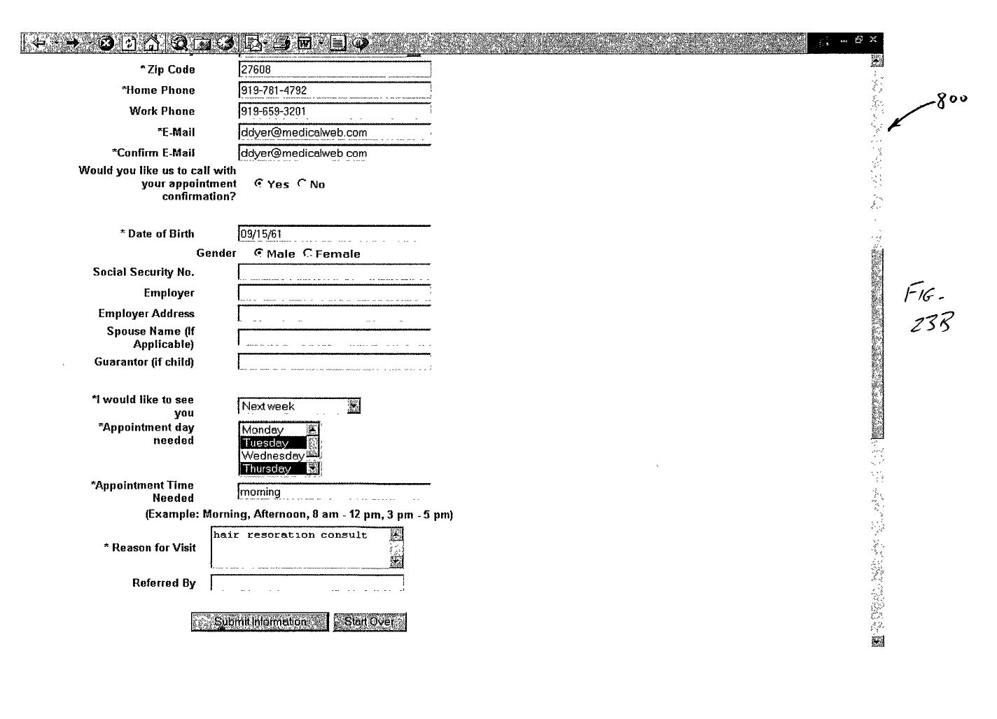

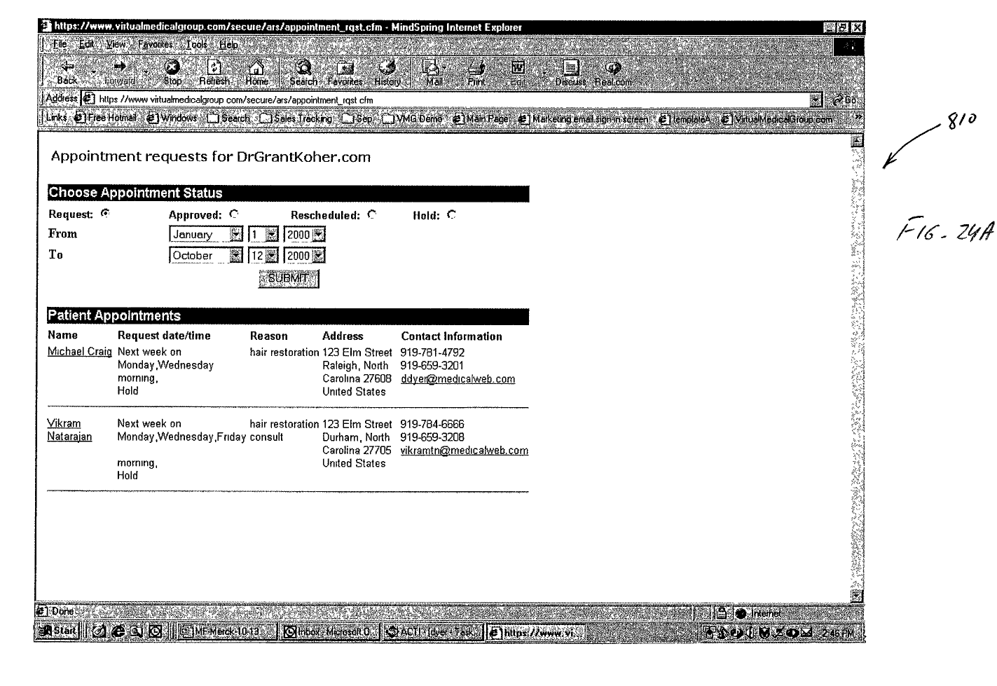

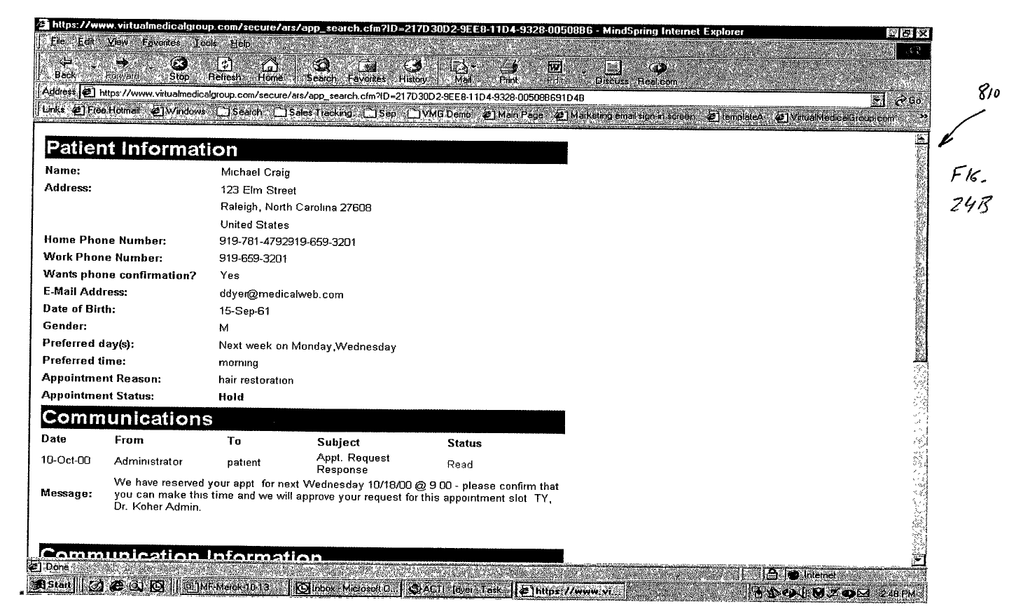

According to embodiments of the present invention, patients may request appointments with various healthcare providers. FIGS. 23A-23B illustrate an exemplary screen 800 for requesting appointments. FIGS. 24A-24B illustrate an exemplary screen 810 for use by healthcare providers for accepting and/or denying appointment requests by patients.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of providing professional services, the method comprising the following performed by a data processing system:
accepting entry of information associated with a matter of a person, wherein the information is entered via a client device in communication with the data processing system;
assigning the person to one of a plurality of pools of people based on the entered information;
allowing a professional services provider qualified to advise people in the assigned pool to view the entered information; and
providing a secure area within which the professional services provider provides information about the matter, wherein the secure area is accessible by the person via the client device.

2. The method according to claim 1, further comprising allowing the person to access the secure area and view the information provided by the professional services provider.

3. The method according to claim 1, further comprising notifying the person that the professional services provider has provided information about the matter within the secure area.

4. The method according to claim 1, wherein the information is entered by the person in a predetermined, structured format.

5. The method according to claim 1, further comprising the following performed prior to accepting entry of information associated with a matter of a person:
identifying the person; and
verifying that the person is eligible to receive professional services.

6. The method according to claim 1, wherein the professional services provider is selected from the group consisting of healthcare service providers, legal service providers, technical service providers, and financial services providers.

7. The method according to claim 1, wherein assigning the person to a pool is based upon one or more attributes of the person and/or one or more attributes of the professional services provider.

8. A method of providing healthcare services to patients, the method comprising the following performed by a data processing system:
accepting entry of information about a medical condition of a patient, wherein the information is entered via a client device in communication with the data processing system;
assigning the patient to one of a plurality of pools of patients based on the entered patient information;
allowing a healthcare provider qualified to treat patients in the assigned pool to view the patient information; and
providing a secure area within which the healthcare provider provides a diagnosis and/or treatment recommendation for the medical condition of the patient, wherein the secure area is accessible by the patient via the client device.

9. The method according to claim 8, further comprising allowing the patient to access the secure area and view the diagnosis and/or treatment recommendation provided by the healthcare provider.

10. The method according to claim 8, further comprising notifying the patient that the healthcare provider has provided a diagnosis and/or treatment recommendation for the medical condition of the patient within the secure area.

11. The method according to claim 8, wherein the information is entered by the patient in a predetermined, structured format.

12. The method according to claim 8, wherein a treatment recommendation provided by the healthcare provider includes a medication prescription, and further comprising communicating the medication prescription to a pharmacy for fulfillment.

13. The method according to claim 8, wherein a treatment recommendation provided by the healthcare provider includes a request to perform laboratory services on the patient, and further comprising communicating the request for laboratory services to a provider of laboratory services for fulfillment.

14. The method according to claim 13, further comprising communicating results of the laboratory services to the patient.

15. The method according to claim 8, further comprising the following performed prior to accepting entry of information about a medical condition of a patient:
identifying the patient; and
verifying that the patient is eligible to receive healthcare services.

16. The method according to claim 8, wherein assigning the patient to a pool is based upon one or more attributes of the patient and/or one or more attributes of the healthcare provider.

17. The method according to claim 9, wherein allowing the patient to access the secure area and view the diagnosis and/or treatment recommendation provided by the healthcare provider comprises allowing the patient to select a specific medication prescription for treating the patient.

18. A data processing system that facilitates the provision of professional services, comprising:
means for accepting entry of information associated with a matter of a person, wherein the information is entered via a client device in communication with the data processing system;
means for assigning the person to one of a plurality of pools of people based on the entered information;
means for allowing a professional services provider qualified to advise people in the assigned pool to view the entered information; and
means for providing a secure area within which the professional services provider provides information about the matter, wherein the secure area is accessible by the person via the client device.

19. The data processing system according to claim 18, further comprising means for allowing the person to access the secure area and view the information provided by the professional services provider.

20. The data processing system according to claim 18, further comprising means for notifying the person that the professional services provider has provided information about the matter within the secure area.

21. The data processing system according to claim 18, wherein the information is entered by the person in a predetermined, structured format.

22. The data processing system according to claim 18, further comprising:
means for identifying the person; and
means for verifying that the person is eligible to receive professional services.

23. The data processing system according to claim 18, wherein the professional services provider is selected from the group consisting of healthcare service providers, legal service providers, technical service providers, and financial services providers.

24. The data processing system according to claim 18, wherein the means for assigning the person to a pool comprises means for assigning the person to a pool based upon one or more attributes of the person and/or one or more attributes of the professional services provider.

25. A data processing system that facilitates the provision of healthcare services to patients, comprising:
means for accepting entry of information about a medical condition of a patient, wherein the information is entered via a client device in communication with the data processing system;
means for assigning the patient to one of a plurality of pools of patients based on the entered patient information;
means for allowing a healthcare provider qualified to treat patients in the assigned pool to view the patient information; and
means for providing a secure area within which the healthcare provider provides a diagnosis and/or treatment recommendation for the medical condition of the patient, wherein the secure area is accessible by the patient via the client device.

26. The data processing system according to claim 25, further comprising means for allowing the patient to access the secure area and view the diagnosis and/or treatment recommendation provided by the healthcare provider.

27. The data processing system according to claim 25, further comprising means for notifying the patient that the healthcare provider has provided a diagnosis and/or treatment recommendation for the medical condition of the patient within the secure area.

28. The data processing system according to claim 25, wherein the information is entered by the patient in a predetermined, structured format.

29. The data processing system according to claim 25, wherein a treatment recommendation provided by the healthcare provider includes a medication prescription, and further comprising means for communicating the medication prescription to a pharmacy for fulfillment.

30. The data processing system according to claim 25, wherein a treatment recommendation provided by the healthcare provider includes a request to perform laboratory services on the patient, and further comprising means for communicating the request for laboratory services to a provider of laboratory services for fulfillment.

31. The data processing system according to claim 25, further comprising:
means for identifying the patient; and
means for verifying that the patient is eligible to receive healthcare services.

32. The data processing system according to claim 25, wherein the means for assigning the patient to a pool comprises means for assigning the patient to a pool based upon one or more attributes of the person and/or one or more attributes of the professional services provider.

33. The data processing system according to claim 26, wherein the means for allowing the patient to access the secure area and view the diagnosis and/or treatment recommendation provided by the healthcare provider comprises means for allowing the patient to select a specific medication prescription for treating the patient.

34. A computer program product that facilitates the provision of professional services, the computer program product comprising a computer usable storage medium having computer readable program code embodied in the medium, the computer readable program code comprising:
computer readable program code that accepts entry of information associated with a matter of a person, wherein the information is entered via a client device in communication with the data processing system;
computer readable program code that assigns the person to one of a plurality of pools of people based on the entered information;
computer readable program code that allows a professional services provider qualified to advise people in the assigned pool to view the entered information; and
computer readable program code that provides a secure area within which the professional services provider provides information about the matter, wherein the secure area is accessible by the person via the client device.

35. The computer program product according to claim 34, further comprising computer readable program code that allows the person to access the secure area and view the information provided by the professional services provider.

36. The computer program product according to claim 34, further comprising computer readable program code that notifies the person that the professional services provider has provided information about the matter within the secure area.

37. The computer program product according to claim 34, wherein the information is entered by the person in a predetermined, structured format.

38. The computer program product according to claim 34, further comprising:
computer readable program code that identifies the person; and
computer readable program code that verifies that the person is eligible to receive professional services.

39. The computer program product according to claim 34, wherein the professional services provider is selected from the group consisting of healthcare service providers, legal service providers, technical service providers, and financial services providers.

40. The computer program product according to claim 34, wherein the computer readable program code that assigns the person to a pool comprises computer readable program code that assigns the person to a pool based upon one or more attributes of the person and/or one or more attributes of the professional services provider.

41. A computer program product that facilitates the provision of healthcare services to patients, the computer program product comprising a computer usable storage medium having computer readable program code embodied in the medium, the computer readable program code comprising:
computer readable program code that accepts entry of information about a medical condition of a patient, wherein the information is entered via a client device in communication with the data processing system;
computer readable program code that assigns the patient to one of a plurality of pools of patients based on the entered patient information;
computer readable program code that allows a healthcare provider qualified to treat patients in the assigned pool to view the patient information; and
computer readable program code that provides a secure area within which the healthcare provider provides a diagnosis and/or treatment recommendation for the medical condition of the patient, wherein the secure area is accessible by the patient via the client device.

42. The computer program product according to claim 41, further comprising computer readable program code that allows the patient to access the secure area and view the diagnosis and/or treatment recommendation provided by the healthcare provider.

43. The computer program product according to claim 41, further comprising computer readable program code that notifies the patient that the healthcare provider has provided a diagnosis and/or treatment recommendation for the medical condition of the patient within the secure area.

44. The computer program product according to claim 41, wherein the information is entered by the patient in a predetermined, structured format.

45. The computer program product according to claim 41, wherein a treatment recommendation provided by the healthcare provider includes a medication prescription, and further comprising computer readable program code that communicates the medication prescription to a pharmacy for fulfillment.

46. The computer program product according to claim 41, wherein a treatment recommendation provided by the healthcare provider includes a request to perform laboratory services on the patient, and further comprising computer readable program code that communicates the request for laboratory services to a provider of laboratory services for fulfillment.

47. The computer program product according to claim 41, further comprising:
computer readable program code that identifies the patient; and
computer readable program code that verifies that the patient is eligible to receive healthcare services.

48. The computer program product according to claim 41, wherein the computer readable program code that assigns the patient to a pool comprises computer readable program code that assigns the patient to a pool based upon one or more attributes of the person and/or one or more attributes of the professional services provider.

49. The computer program product according to claim 42, wherein the computer readable program code that allows the patient to access the secure area and view the diagnosis and/or treatment recommendation provided by the healthcare provider comprises computer readable program code that allows the patient to select a specific medication prescription for treating the patient.
